(19) United States
(12) Patent Application Publication
(10) Pub. No.: US 2026/0283749 A1
(43) Pub. Date: Sep. 24, 2026

(54) MULTILAYER SHEET

(71) Applicant: Eastman Chemical Company, Kingsport, TN (US)

(72) Inventors: Robbie Rene Meul, Hamme (BE); Sophie Ann Ruddick, Liverpool (GB); Mark Allen Peters, Telford, TN (US)

(73) Assignee: Eastman Chemical Company, Kingsport, TN (US)

(21) Appl. No.: 19/475,799

(22) PCT Filed: Apr. 23, 2024
(86) PCT No.: PCT/US2024/025750

§ 371 Date: Oct. 16, 2025

Related U.S. Application Data
(60) Provisional application No. 63/498,080, filed on Apr. 25, 2023.

(51) Int. Cl. A61C 7/08

(52) U.S. Cl. CPC A61C 7/08; A61C 2201/00

(57) ABSTRACT

Provided are copolyester multilayer film/sheet structures which exhibit improved stain resistance and high modulus properties which can be useful in many applications, including formed articles for use in the dental appliance market.

### FIELD OF THE INVENTION

This invention belongs generally to the field of thermoplastic polymers. In particular, it relates to polymeric sheets useful in the manufacture of three-dimensional thermoformed articles, such as dental appliances.

### Background of the Invention

Traditionally, metal braces have been used to reposition teeth for improved function or appearance. In recent years, metal braces have been supplanted in many cases by clear, plastic dental aligners. Aligners are thermoformed appliances which fit over the patient's teeth, designed to gradually move them to a desired position. Aligners must be stiff enough to exert an initial force on the teeth, able to maintain a sufficient force over a period of time and be durable (resist cracking). Aligners can be made from a monolayer plastic sheet, but multilayer sheet (consisting of two or more distinct layers of plastic) allows more freedom to tailor properties to specific needs.

### SUMMARY OF THE INVENTION

The invention is as set forth in the appended claims. In general, the invention relates to multilayer film/sheet structures which exhibit improved stain resistance, are durable, and have flexural and tensile modulus properties which can be useful in many applications, including thermoformed articles for use in the dental appliance market. These structures can be produced through extrusion, lamination, or other means known to those skilled in the art.

In an aspect, multilayer film/sheet structures are provided that have a combination of good tear force and force retention properties, and stain resistance, while maintaining sufficiently high flexural and tensile modulus (for the overall sheet structure).

### DETAILED DESCRIPTION OF THE INVENTION

The term “film”, as used herein, includes both film and sheet, and is intended to have its commonly accepted meaning in the art. The term “sheet” is also understood to include both single layer and multilayer sheets.

As used herein, the singular forms “a”, “an”, and “the” include their plural referents unless the context clearly dictates otherwise. The terms “containing” or “including” are intended to be synonymous with the term “comprising”, meaning that at least the named compound, element, particle, or method step, etc., is present in the composition or article but does not exclude the presence of other compounds, materials, method steps, etc., even if the other such compounds, material, particles, method steps, etc., have the same function as what is named, unless expressly excluded in the claims.

In a first aspect, the invention provides a multilayer sheet comprising at least two layers, said at least two layers comprising a first layer and a second layer, wherein:
(A) said first layer comprises a polyester comprising:
   (a) a dicarboxylic acid component comprising:
      i) 70 to 100 mole % of terephthalic acid residues; and
      ii) 0 to 30 mole % of aromatic and/or aliphatic dicarboxylic acid residues having up to 20 carbon atoms; and
   (b) a glycol component comprising:
      i) 10 to 40 mole % of 2,2,4,4-tetramethyl-1,3-cyclobutanediol residues;
      ii) 0 to 90 mole % of 1,4-cyclohexanedimethanol residues; and
      iii) 0 to 90 mole % of ethylene glycol residues; and
having an inherent viscosity of about 0.4 to about 1.2 dL/g as determined in 60/40 (wt/wt) phenol/tetrachloroethane at a concentration of 0.5 g/100 ml at 25° C.; and
(B) said second layer comprises a polyester comprising:
   (a) a dicarboxylic acid component comprising:
      i) 70 to 100 mole % of dicyclohexane dicarboxylic acid residues;
      ii) 0 to 30 mole % of aromatic and/or aliphatic dicarboxylic acid residues having up to 20 carbon atoms; and
   (b) a glycol component comprising:
      i) 40 to 100 mole % of 1,4-cyclohexanedimethanol residues;
      ii) 0 to 60 mole % of ethylene glycol residues; and
having an inherent viscosity of 0.5 to 1.2 dL/g as determined in 60/40 (wt/wt) phenol/tetrachloroethane at a concentration of 0.5 g/100 ml at 25° C.; and
   wherein the overall thickness of the sheet is between 100 and 3000 microns.

In embodiments, the first layer can comprise a polyester comprising:
(a) a dicarboxylic acid component comprising:
   i) 90 to 100 mole % of terephthalic acid residues;
   ii) 0 to 10 mole % of aromatic and/or aliphatic dicarboxylic acid residues having up to 20 carbon atoms; and
(b) a glycol component comprising:
   i) 10 to 40 mole % of 2,2,4,4-tetramethyl-1,3-cyclobutanediol residues;
   ii) 60 to 90 mole % of 1,4-cyclohexanedimethanol residues; and
has an inherent viscosity of about 0.5 to about 0.9 dL/g as determined in 60/40 (wt/wt) phenol/tetrachloroethane at a concentration of 0.5 g/100 ml at 25° C. In another embodiment, the inherent viscosity of said first layer is between about 0.6 and 0.8 dL/g.

In embodiments, the first layer can comprise a polyester comprising:
(a) a dicarboxylic acid component comprising:
   i) 90 to 100 mole % of terephthalic acid residues;
   ii) 0 to 10 mole % of aromatic and/or aliphatic dicarboxylic acid residues having up to 20 carbon atoms; and
(b) a glycol component comprising:
   i) 10 to 40 mole % of 2,2,4,4-tetramethyl-1,3-cyclobutanediol residues;
   ii) 60 to 90 mole % of ethylene glycol residues; and
has an inherent viscosity of about 0.4 to about 0.9 dL/g as determined in 60/40 (wt/wt) phenol/tetrachloroethane at a concentration of 0.5 g/100 ml at 25° C. In another embodiment, the inherent viscosity of said first layer is between about 0.5 and 0.7 dL/g.

In another aspect, the first layer comprises a polyester comprising:
(a) a dicarboxylic acid component comprising:
   i) 70 to 100 mole % of terephthalic acid residues; and
   ii) 0 to 30 mole % of aromatic and/or aliphatic dicarboxylic acid residues having up to 20 carbon atoms; and
(b) a glycol component comprising:
   i) 2 to 40, or 2 to 20, or 2 to 10, or 10 to 40, or 10 to 30, or 10 to 20 mole % of isosorbide residues;
   ii) 0 to 90 mole % of 1,4-cyclohexanedimethanol residues; and
   iii) 0 to 90 mole % of ethylene glycol residues; and
having an inherent viscosity of about 0.4 to about 0.9 dL/g as determined in 60/40 (wt/wt) phenol/tetrachloroethane at a concentration of 0.5 g/100 ml at 25° C.

In embodiments, the second layer comprises a polyester which comprises a dicarboxylic acid component comprising residues of 1,4-cyclohexane dicarboxylate and a diol component comprising residues of 1,4-cyclohexanedimethanol.

In embodiments, the second layer comprises a polyester that comprises:
(a) a dicarboxylic acid component comprising:
   i) 90 to 100 mole % of 1,4-cyclohexane dicarboxylic acid residues;
   ii) 0 to 10 mole % of aromatic and/or aliphatic dicarboxylic acid residues having up to 20 carbon atoms;
and
(b) a glycol component comprising:
   i) 90 to 100 mole % of 1,4-cyclohexanedimethanol residues, and
   ii) 0 to 10 mole % of modifying glycol residues; and
having an inherent viscosity of about 0.5 to about 1.2 dL/g as determined in 60/40 (wt/wt) phenol/tetrachloroethane at a concentration of 0.5 g/100 ml at 25° C. In one embodiment, the dicarboxylic acid component comprises 100 mole % of 1,4-cyclohexane dicarboxylic acid residues, and the glycol component comprises 100 mole % of 1,4-cyclohexanedimethanol residues.

In another embodiment, the second layer further comprises an additional copolyester comprising:
(a) a dicarboxylic acid component comprising:
   i) 90 to 100 mole % of trans-1,4-cyclohexane dicarboxylic acid residues;
   ii) 0 to 10 mole % of aromatic and/or aliphatic dicarboxylic acid residues having up to 20 carbon atoms;
and
(b) a glycol component comprising:
   i) 95 to 80 mole % of 1,4-cyclohexanedimethanol residues, and
   ii) 5 to 20 mole % of poly(tetramethylene ether)glycol residues; and
has an inherent viscosity of about 0.9 to about 1.4 dL/g as determined in 60/40 (wt/wt) phenol/tetrachloroethane at a concentration of 0.5 g/100 ml at 25° C. In another embodiment, the inherent viscosity ranges from about 1.02 to about 1.26.

In certain embodiments, the second layer can include a blend of a first polyester that comprises cyclohexane dicarboxylate (CHDA) and cyclohexanedimethanol (CHDM), with one or more additional polyester(s) as described herein for the second layer. In embodiments, this blend comprises the first polyester in an amount from greater than 30 up to 99 wt % and the one or more additional polyesters in a total amount from 1 to less than 70 wt %.

Examples of suitable first layer polyester materials, depending on the application, can include Eastman Tritan™ MP100, TX1000, TX1500, TX2000, TX1 800, MX710, MX711, MX810, MX900 and MX730 copolyesters, available from Eastman Chemical Company. Examples of suitable second layer polyester materials, depending on the application, can include Neostar™ Polyester 19972, available from Eastman Chemical Company. In certain embodiments, the second layer can include minor amounts of Ecdel™ Elastomer 9966 (and/or 9967) and/or Eastar™ Copolyester 6763, available from Eastman Chemical Company.

The term “polyester”, as used herein, is intended to include “copolyesters” and is understood to mean a synthetic polymer prepared by the reaction of one or more difunctional carboxylic acids and/or multifunctional carboxylic acids with one or more difunctional hydroxyl compounds and/or multifunctional hydroxyl compounds. Typically, the difunctional carboxylic acid can be a dicarboxylic acid and the difunctional hydroxyl compound can be a dihydric alcohol such as, for example, glycols. The term “glycol” as used herein includes, but is not limited to, diols, glycols, and/or multifunctional hydroxyl compounds. The term “residue”, as used herein, means any organic structure incorporated into a polymer through a polycondensation and/or an esterification reaction from the corresponding monomer. The term “repeating unit”, as used herein, means an organic structure having a dicarboxylic acid residue and a diol residue bonded through a carbonyloxy or ester group. Thus, for example, the dicarboxylic acid residues may be derived from a dicarboxylic acid monomer or its associated acid halides, esters, salts, anhydrides, or mixtures thereof. As used herein, therefore, the term dicarboxylic acid is intended to include dicarboxylic acids and any derivative of a dicarboxylic acid, including its associated acid halides, esters, half-esters, salts, half-salts, anhydrides, mixed anhydrides, or mixtures thereof, useful in a reaction process with a diol to make polyester. As used herein, the term “terephthalic acid” is intended to include terephthalic acid itself and residues thereof as well as any derivative of terephthalic acid, including its associated acid halides, esters, half-esters, salts, half-salts, anhydrides, mixed anhydrides, or mixtures thereof or residues thereof useful in a reaction process with a diol to make polyester.

In one embodiment, terephthalic acid may be used as the starting material. In another embodiment, dimethyl terephthalate may be used as the starting material. In another embodiment, mixtures of terephthalic acid and dimethyl terephthalate may be used as the starting material and/or as an intermediate material.

The polyesters used in the present invention typically can be prepared from dicarboxylic acids and diols which react in substantially equal proportions and are incorporated into the polyester polymer as their corresponding residues. The polyesters of the present invention, therefore, can contain substantially equal molar proportions of acid residues (100 mole %) and diol (and/or multifunctional hydroxyl compounds) residues (100 mole %) such that the total moles of repeating units is equal to 100 mole %. The mole percentages provided herein, therefore, may be based on the total moles of acid residues, the total moles of diol residues, or the total moles of repeating units. For example, a polyester containing 30 mole % isophthalic acid, based on the total acid residues, means the polyester contains 30 mole % isophthalic acid residues out of a total of 100 mole % acid residues. Thus, there are 30 moles of isophthalic acid residues among every 100 moles of acid residues. In another example, a polyester containing 30 mole % 2,2,4,4-tetramethyl-1,3-cyclobutanediol, based on the total diol residues, means the polyester contains 30 mole % 2,2,4,4-tetramethyl-1,3-cyclobutanediol residues out of a total of 100 mole % diol residues. Thus, there are 30 moles of 2,2,4,4-tetramethyl-1,3-cyclobutanediol residues among every 100 moles of diol residues.

For a desired polyester that contains TMCD, the molar ratio of cis/trans 2,2,4,4-tetramethyl-1,3-cyclobutanediol can vary from the pure form of each or mixtures thereof. In certain embodiments, the molar percentages for cis and/or trans 2,2,4,4,-tetramethyl-1,3-cyclobutanediol are greater than 50 mole % cis and less than 50 mole % trans; or greater than 55 mole % cis and less than 45 mole % trans; or 30 to 70 mole % cis and 70 to 30% trans; or 40 to 60 mole % cis and 60 to 40 mole % trans; or 50 to 70 mole % trans and 50 to 30% cis or 50 to 70 mole % cis and 50 to 30% trans; or 60 to 70 mole % cis and 30 to 40 mole % trans; or greater than 70 mole cis and less than 30 mole % trans; wherein the total sum of the mole percentages for cis- and trans-2,2,4,4-tetramethyl-1,3-cyclobutanediol is equal to 100 mole %. In embodiments, the molar ratio of cis/trans 1,4-cyclohexanedimethanol can vary within the range of 50/50 to 0/100, such as between 40/60 to 20/80.

In certain embodiments of the first layer copolyester, terephthalic acid or an ester thereof, such as, for example, dimethyl terephthalate, or a mixture of terephthalic acid and an ester thereof, makes up most or all of the dicarboxylic acid component used to form the polyesters useful in the invention. In certain embodiments, terephthalic acid residues can make up a portion or all of the dicarboxylic acid component used to form the present polyester at a concentration of at least 70 mole %, such as at least 80 mole %, at least 90 mole %, at least 95 mole %, at least 99 mole %, or 100 mole %. In certain embodiments, higher amounts of terephthalic acid can be used in order to produce a higher impact strength polyester. In one embodiment, dimethyl terephthalate is part, or all of the dicarboxylic acid component used to make the polyesters useful in the present invention. As used herein, the terms “terephthalic acid” and “dimethyl terephthalate” are used interchangeably.

In addition to terephthalic acid, the dicarboxylic acid component of the copolyester useful in the first layer can comprise up to 30 mole %, up to 20 mole %, up to 10 mole %, up to 5 mole %, or up to 1 mole % of one or more modifying aromatic dicarboxylic acids. Yet another embodiment contains 0 mole % modifying aromatic dicarboxylic acids. Thus, if present, it is contemplated that the amount of one or more modifying aromatic dicarboxylic acids can range from any of these preceding endpoint values including, for example, from 0.01 to 30 mole %, 0.01 to 20 mole %, from 0.01 to 10 mole %, from 0.01 to 5 mole % and from 0.01 to 1 mole. In one embodiment, modifying aromatic dicarboxylic acids that may be used in the present invention include but are not limited to those having up to 20 carbon atoms, and which can be linear, para-oriented, or symmetrical. Examples of modifying aromatic dicarboxylic acids which may be used in this invention include, but are not limited to, isophthalic acid, 4,4′-biphenyldicarboxylic acid, 1,4-, 1,5-, 2,6-, 2,7-naphthalenedicarboxylic acid, and trans-4,4′-stilbenedicarboxylic acid, and esters thereof. In one embodiment, the modifying aromatic dicarboxylic acid is isophthalic acid.

The carboxylic acid component of the polyesters useful in the invention can be further modified with up to 10 mole %, such as up to 5 mole % or up to 1 mole % of one or more aliphatic dicarboxylic acids containing up to 20 carbon atoms, such as, for example, malonic, succinic, glutaric, adipic, pimelic, suberic, azelaic and dodecanedioic dicarboxylic acids. Certain embodiments can also comprise 0.01 or more mole %, such as 0.1 or more mole %, 1 or more mole %, 5 or more mole %, or 10 or more mole % of one or more modifying aliphatic dicarboxylic acids. Yet another embodiment contains 0 mole % modifying aliphatic dicarboxylic acids. Thus, if present, it is contemplated that the amount of one or more modifying aliphatic dicarboxylic acids can range from any of these preceding endpoint values including, for example, from 0.01 to 10 mole % and from 0.1 to 10 mole %. The total mole % of the dicarboxylic acid component is 100 mole %.

Esters of terephthalic acid and the other modifying dicarboxylic acids or their corresponding esters and/or salts may be used instead of the dicarboxylic acids. Suitable examples of dicarboxylic acid esters include, but are not limited to, the dimethyl, diethyl, dipropyl, diisopropyl, dibutyl, and diphenyl esters. In one embodiment, the esters are chosen from at least one of the following: methyl, ethyl, propyl, isopropyl, and phenyl esters.

The 1,4-cyclohexanedimethanol may be cis, trans, or a mixture thereof, for example a cis/trans ratio of 20:80 to 40:60, or 40:60 to 60:40. In one embodiment, the trans-1,4-cyclohexanedimethanol can be present in an amount of 60 to 80 mole %.

In certain embodiments of the first layer copolyester, the glycol component of the copolyesters described above can contain up to 35 mole % of one or more modifying glycols which are not 2,2,4,4-tetramethyl-1,3-cyclobutanediol or 1,4-cyclohexanedimethanol.

Modifying glycols useful in the polyesters can be diols other than 2,2,4,4,-tetramethyl-1,3-cyclobutanediol and 1,4-cyclohexanedimethanol and may contain 2 to 16 carbon atoms. Examples of suitable modifying glycols include, but are not limited to, ethylene glycol, 1,2-propanediol, 1,3-propanediol, neopentyl glycol, 1,4-butanediol, 1,5-pentanediol, 1,6-hexanediol, p-xylene glycol, isosorbide or mixtures thereof. In one embodiment, the modifying glycol is ethylene glycol. In another embodiment, the modifying glycols are 1,3-propanediol and/or 1,4-butanediol. In another embodiment, ethylene glycol is excluded as a modifying diol. In another embodiment, 1,3-propanediol and 1,4-butanediol are excluded as modifying diols. In another embodiment, 2,2-dimethyl-1,3-propanediol is excluded as a modifying diol.

In embodiments, the polyesters as described herein (in embodiments for the first layer) can further comprise from 0 to 10 mole percent, for example, from 0.01 to 5 mole percent, from 0.01 to 1 mole percent, from 0.05 to 5 mole percent, from 0.05 to 1 mole percent, or from 0.1 to 0.7 mole percent, based the total mole percentages of either the diol or diacid residues; respectively, of one or more residues of a branching monomer, also referred to herein as a branching agent, having 3 or more carboxyl substituents, hydroxyl substituents, or a combination thereof. In certain embodiments, the branching monomer or agent may be added prior to and/or during and/or after the polymerization of the polyester. The polyester(s) useful in the invention can thus be linear or branched.

Examples of branching monomers include, but are not limited to, multifunctional acids or multifunctional alcohols such as trimellitic acid, trimellitic anhydride, pyromellitic dianhydride, trimethylolpropane, glycerol, pentaerythritol, citric acid, tartaric acid, 3-hydroxyglutaric acid and the like. In one embodiment, the branching monomer residues can comprise 0.1 to 0.7 mole percent of one or more residues chosen from at least one of the following: trimellitic anhydride, pyromellitic dianhydride, glycerol, sorbitol, 1,2,6-hexanetriol, pentaerythritol, trimethylolethane, and/or trimesic acid. The branching monomer may be added to the polyester reaction mixture or blended with the polyester in the form of a concentrate as described, for example, in U.S. Pat. Nos. 5,654,347 and 5,696,176, whose disclosure regarding branching monomers is incorporated herein by reference.

In certain embodiments, the Tg of the TMCD containing polyesters useful for the first layer can be from about 70 to 150° C., or 90 to 130° C., or 100 to 120° C. In certain embodiments, the Tg of the 1,4-cyclohexane dicarboxylate containing polyesters useful for the second layer can be from about 30 to 110° C., or 50 to 90° C., or 60 to 80° C., or 60 to 70° C. In certain embodiments, the Tg of the additional polyesters containing a polyether segment useful for the second layer can be from about −80 to 50° C., or −60 to 20° C., or −50 to −20° C. The glass transition temperature (Tg) of the polyesters can be determined using a TA DSC 2920 from Thermal Analyst Instrument at a scan rate of 20° C./min.

In addition, the polyester compositions useful in this invention may also contain from 0.01 to 25% by weight or 0.01 to 20% by weight or 0.01 to 15% by weight or 0.01 to 10% by weight or 0.01 to 5% by weight of the total weight of the polyester composition of common additives such as colorants, dyes, slip or release agents, and/or stabilizers, including but not limited to thermal or hydrolytic stabilizers.

In certain embodiments, where the first layer comprises copolyesters containing TMCD and CHDM residues, the glycol component for the polyesters can include but is not limited to at least one of the following combinations of ranges: 10 to 40 mole % 2,2,4,4-tetramethyl-1,3-cyclobutanediol and 60 to 90 mole % 1,4-cyclohexanedimethanol; 10 to 35 mole % 2,2,4,4-tetramethyl-1,3-cyclobutanediol and 65 to 90 mole % 1,4-cyclohexanedimethanol; 10 to less than 35 mole % 2,2,4,4-tetramethyl-1,3-cyclobutanediol and greater than 65 up to 90 mole % 1,4-cyclohexanedimethanol; 10 to 30 mole % 2,2,4,4-tetramethyl-1,3-cyclobutanediol and 70 to 90 mole % 1,4-cyclohexanedimethanol; 10 to 25 mole % 2,2,4,4-tetramethyl-1,3-cyclobutanediol and greater than 75 to 90 mole % 1,4-cyclohexanedimethanol; 11 to 25 mole % 2,2,4,4-tetramethyl-1,3-cyclobutanediol and 75 to 89 mole % 1,4-cyclohexanedimethanol; 12 to 25 mole % 2,2,4,4-tetramethyl-1,3-cyclobutanediol and 75 to 88 mole % 1,4-cyclohexanedimethanol; and 13 to 25 mole % 2,2,4,4-tetramethyl-1,3-cyclobutanediol and 75 to 87 mole % 1,4-cyclohexanedimethanol.

In other embodiments, the glycol component for the polyesters can include but is not limited to at least one of the following combinations of ranges: 15 to 40 mole % 2,2,4,4-tetramethyl-1,3-cyclobutanediol and 60 to 85 mole % 1,4-cyclohexanedimethanol; 15 to 35 mole % 2,2,4,4-tetramethyl-1,3-cyclobutanediol and 65 to 85 mole % 1,4-cyclohexanedimethanol; 15 to 30 mole % 2,2,4,4-tetramethyl-1,3-cyclobutanediol and 70 to 85 mole % 1,4-cyclohexanedimethanol; 15 to 25 mole % 2,2,4,4-tetramethyl-1,3-cyclobutanediol and 75 to 85 mole % 1,4-cyclohexanedimethanol; 15 to 20 mole % 2,2,4,4-tetramethyl-1,3-cyclobutanediol and 75 to 80 mole % 1,4-cyclohexanedimethanol; and 17 to 23 mole % 2,2,4,4-tetramethyl-1,3-cyclobutanediol and 77 to 83 mole % 1,4-cyclohexanedimethanol.

In other embodiments, where the first layer comprises copolyesters containing TMCD and CHDM residues, the glycol component for the polyesters can include but is not limited to at least one of the following combinations of ranges: 20 to 40 mole % 2,2,4,4-tetramethyl-1,3-cyclobutanediol and 60 to 80 mole % 1,4-cyclohexanedimethanol; 20 to 35 mole % 2,2,4,4-tetramethyl-1,3-cyclobutanediol and 65 to 80 mole % 1,4-cyclohexanedimethanol; 20 to 30 mole % 2,2,4,4-tetramethyl-1,3-cyclobutanediol and 70 to 80 mole % 1,4-cyclohexandimethanol; and 20 to 25 mole % 2,2,4,4-tetramethyl-1,3-cyclobutanediol and 75 to 80 mole % 1,4-cyclohexanedimethanol.

In other embodiments, where the first layer comprises copolyesters containing TMCD and CHDM residues, the glycol component for the polyesters can include but is not limited to at least one of the following combinations of ranges: 25 to 40 mole % 2,2,4,4-tetramethyl-1,3-cyclobutanediol and 60 to 75 mole % 1,4-cyclohexanedimethanol; 25 to 35 mole % 2,2,4,4-tetramethyl-1,3-cyclobutanediol and 65 to 75 mole % 1,4-cyclohexanedimethanol; and 25 to 30 mole % 2,2,4,4-tetramethyl-1,3-cyclobutanediol and 70 to 75 mole % 1,4-cyclohexanedimethanol; 30 to 40 mole % 2,2,4,4-tetramethyl-1,3-cyclobutanediol and 60 to 70 mole % 1,4-cyclohexanedimethanol; 30 to 35 mole % 2,2,4,4-tetramethyl-1,3-cyclobutanediol and 65 to 70 mole % 1,4-cyclohexanedimethanol.

In certain embodiments, where the first layer comprises copolyesters containing TMCD and CHDM residues, the copolyesters can contain less than 15 mole % ethylene glycol residues, such as, for example, 0.01 to less than 15 mole % ethylene glycol residues. In embodiments, the polyesters useful in the invention contain less than 10 mole %, or less than 5 mole %, or less than 4 mole %, or less than 2 mole %, or less than 1 mole % ethylene glycol residues, such as, for example, 0.01 to less than 10 mole %, or 0.01 to less than 5 mole %, or 0.01 to less than 4 mole %, or 0.01 to less than 2 mole %, or 0.01 to less than 1 mole %, ethylene glycol residues. In one embodiment, the copolyesters useful in the invention contain no ethylene glycol residues.

In certain embodiments, where the first layer comprises copolyesters containing isosorbide and CHDM residues, the glycol component for the polyesters can include but is not limited to at least one of the following combinations of ranges: 2 to 40 mole % isosorbide, 20 to 93 mole % 1,4-cyclohexanedimethanol, and 5 to 40 mole % EG; 10 to 40 mole % isosorbide, 20 to 80 mole % 1,4-cyclohexanedimethanol, and 10 to 40 mole % EG; 10 to 35 mole % isosorbide, 25 to 80 mole % 1,4-cyclohexanedimethanol, and 10 to 40 mole % EG; 10 to less than 35 mole % isosorbide, greater than 25 up to 80 mole % 1,4-cyclohexanedimethanol, and 10 to 40 mole % EG; 10 to 30 mole % isosorbide, 30 to 80 mole % 1,4-cyclohexanedimethanol, and 10 to 40 mole % EG; 10 to 25 mole % isosorbide, 35 to 80 mole % 1,4-cyclohexanedimethanol, and 10 to 40 mole % EG; 11 to 25 mole % isosorbide, 35 to 79 mole % 1,4-cyclohexanedimethanol, and 10 to 40 mole % EG; 12 to 25 mole % isosorbide, 35 to 78 mole % 1,4-cyclohexanedimethanol, and 10 to 40 mole % EG; and 13 to 25 mole % isosorbide, 35 to 77 mole % 1,4-cyclohexanedimethanol, and 10 to 40 mole % EG.

In other embodiments, the glycol component for the polyesters can include but is not limited to at least one of the following combinations of ranges: 15 to 40 mole % isosorbide, 20 to 75 mole % 1,4-cyclohexanedimethanol, and 10 to 40 mole % EG; 15 to 35 mole % isosorbide, 25 to 75 mole % 1,4-cyclohexanedimethanol, and 10 to 40 mole % EG; 15 to 30 mole % isosorbide, 30 to 75 mole % 1,4-cyclohexanedimethanol, and 10 to 40 mole % EG; 15 to 25 mole % isosorbide, 35 to 75 mole % 1,4-cyclohexanedimethanol, and 10 to 40 mole % EG; 15 to 20 mole % isosorbide, 40 to 75 mole % 1,4-cyclohexanedimethanol, and 10 to 40 mole % EG; 17 to 23 mole % isosorbide, 37 to 73 mole % 1,4-cyclohexanedimethanol, and 10 to 40 mole % EG; 15 to 30 mole % isosorbide, 40 to 75 mole % 1,4-cyclohexanedimethanol, and 10 to 30 mole % EG; 20 to 30 mole % isosorbide, 40 to 65 mole % 1,4-cyclohexanedimethanol, and 15 to 30 mole % EG.

In other embodiments, the glycol component for the polyesters can include but is not limited to at least one of the following combinations of ranges: 10 to 30 mole % isosorbide, 40 to 65 mole % 1,4-cyclohexanedimethanol, and 30 to 45 mole % EG; 20 to 30 mole % isosorbide, 40 to 60 mole % 1,4-cyclohexanedimethanol, and 20 to 30 mole % EG; 20 to 35 mole % isosorbide, 40 to 55 mole % 1,4-cyclohexanedimethanol, and 20 to 30 mole % EG.

In embodiments, where the first layer comprises copolyesters containing TMCD and EG residues, the polyesters can include a copolyester comprising: (a) diacid residues comprising from about 90 to 100 mole percent of TPA residues and from 0 to about 10 mole percent IPA residues; and (b) diol residues comprising at least 60 mole percent of EG residues and up to 40 mole percent of TMCD residues, wherein the copolyester comprises a total of 100 mole percent diacid residues and a total of 100 mole percent diol residues.

In embodiments, the copolyester comprises diol residues comprising from 10 to 40 mole percent TMCD residues and 60 to 90 mole percent EG residues. In embodiments, the copolyester comprises diol residues comprising 20 to 37 mole percent TMCD residues and 63 to 80 mole percent EG residues. In one embodiment, the copolyester comprises diol residues comprising 22 to 35 mole percent TMCD residues and 65 to 78 mole percent EG residues. In certain embodiments, where the first layer comprises copolyesters containing TMCD and EG residues, the copolyester comprises: a) a dicarboxylic acid component comprising: (i) 90 to 100 mole % terephthalic acid residues; and (ii) about 0 to about 10 mole % of aromatic and/or aliphatic dicarboxylic acid residues having up to 20 carbon atoms; and (b) a glycol component comprising: (i) about 10 to about 27 mole % 2,2,4,4-tetramethyl-1,3-cyclobutanediol (TMCD) residues; and (ii) about 90 to about 73 mole % ethylene glycol residues; and wherein the total mole % of the dicarboxylic acid component is 100 mole %, and wherein the total mole % of the glycol component is 100 mole %; and wherein the inherent viscosity (IV) of the polyester is from 0.50 to 0.8 dL/g as determined in 60/40 (wt/wt) phenol/tetrachloroethane at a concentration of 0.25 g/50 ml at 25° C.; and wherein the L* color values for the polyester is 90 or greater, as determined by the L*a*b* color system measured following ASTM D 6290-98 and ASTM E308-99, performed on polymer granules ground to pass a 1 mm sieve. In embodiments, the L* color values for the polyester is greater than 90, as determined by the L*a*b* color system measured following ASTM D 6290-98 and ASTM E308-99, performed on polymer granules ground to pass a 1 mm sieve.

In embodiments, L*, a* and b* can be determined by the L*a*b* color system measured following ASTM E1348, performed on polymer plaques or films. Pellet color is measured in reflectance mode according to ASTM D6290. Plaque/film color is measured in transmittance mode according to ASTM E1348. Color measurements made in transmittance or reflectance are converted to CIE tristimulus values according to ASTM E308. Delta E calculations are determined according to ASTM D2244 by the following equation: ((L*−100)²+(a*−0)²+(b*−0)²)^{1/2}, where the L*, a*, and b* color components were measured according to ASTM E1348.

In embodiments of the invention, the polymer-based resin has a ΔE value of less than 25, or less than 20, or less than 15, or less than 14, or less than 13, or less than 12, or less than 11, or less than 10, or less than 9, or less than 8, or less than 7, or less than 6, or less than 5, using a 3.2 mm plaque after injection molding with a barrel temperature of 249° C. and a mold temperature of 80° C., wherein ΔE is determined by the following equation: ((L*−100)²+(a*−0)²+(b*−0)²)^{1/2}, where the L*, a*, and b* color components were measured according to ASTM E1348. In certain embodiments, the polymer-based resin has a ΔE value in the range from 2 to 25, or from 2 to 20, or from 2 to 15, or from 2 to 14, or from 2 to 13, or from 2 to 12, or from 2 to 11, or from 2 to 10, or from 2 to 9, or from 2 to 8, or from 2 to 7, or from 2 to 6, or from 2 to 5, using a 3.2 mm plaque after injection molding with a barrel temperature of 249° C. and a mold temperature of 80° C., wherein ΔE is determined by the following equation: ((L*−100)²+(a*−0)²+(b*−0)²)^{1/2}, where the L*, a*, and b* color components were measured according to ASTM E1348. In embodiments, the ΔE values can be determined using the formed films having a thickness of approximately 750 microns.

In embodiments, the sheet (or film) has a (ΔE) after exposure to coffee by submerging a test sheet sample cut from a film having a thickness of approximately 750 microns to a size of about 2.5 cm (1 inch) wide and 5.1 cm (2 inches) long at 37° C. for 24 hours of less than 10 or less than 5, or less than 4, or less than 3, or less than 2, or less than 1. In embodiments, the sheet (or film) has a (ΔE) after exposure to coffee by submerging a test sheet sample cut to a size of about 2.5 cm (1 inch) wide and 5.1 cm (2 inches) long at 37° C. for 24 hours in a range of 0.1 to 10, or 0.1 to 5, or 0.1 to 4, or 0.1 to 3, or 0.1 to 2, or 0.1 to 1, or 0.2 to 10, or 0.2 to 5, or 0.2 to 4, or 0.2 to 3, or 0.2 to 2, or 0.2 to 1, or 0.3 to 10, or 0.3 to 5, or 0.3 to 4, or 0.3 to 3, or 0.3 to 2, or 0.3 to 1.

In certain embodiments, the glycol component of the copolyester comprises: (i) about 15 to about 25 mole % 2,2,4,4-tetramethyl-1,3-cyclobutanediol (TMCD) residues; and (ii) about 85 to about 75 mole % ethylene glycol residues; or (i) about 20 to about 25 mole % 2,2,4,4-tetramethyl-1,3-cyclobutanediol (TMCD) residues; and (ii) about 80 to about 75 mole % ethylene glycol residues; or (i) about 21 to about 24 mole % 2,2,4,4-tetramethyl-1,3-cyclobutanediol (TMCD) residues; and (ii) about 86 to about 79 mole % ethylene glycol residues.

In embodiments, where the first layer comprises copolyesters containing TMCD and EG residues, the copolyester has at least one of the following properties chosen from: a Tg of from about 90 to about 108° C. as measured by a TA 2100 Thermal Analyst Instrument at a scan rate of 20° C./min, a flexural modulus at 23° C. of greater than about 2000 MPa (290,000 psi) as defined by ASTM D790, and a notched Izod impact strength greater than about 25 J/m (0.47 ft-lb/in) according to ASTM D256 with a 10-mil notch using a ⅛-inch thick bar at 23° C. In one embodiment, the L* color values for the copolyester is 90 or greater, or greater than 90, as determined by the L*a*b* color system measured following ASTM D 6290-98 and ASTM E308-99, performed on polymer granules ground to pass a 1 mm sieve.

In one embodiment, where the first layer comprises copolyesters containing TMCD and EG residues, the copolyester further comprises: (II) a catalyst/stabilizer component comprising: (i) titanium atoms in the range of 10-50 ppm based on polymer weight, (ii) optionally, manganese atoms in the range of 10-100 ppm based on polymer weight, and (iii) phosphorus atoms in the range of 10-200 ppm based on polymer weight. In one embodiment, the 2,2,4,4-tetramethyl-1,3-cyclobutanediol residues is a mixture comprising more than 50 mole % of cis-2,2,4,4-tetramethyl-1,3-cyclobutanediol residues and less than 50 mole % of trans-2,2,4,4-tetramethyl-1,3-cyclobutanediol residues.

In certain embodiments, where the first layer comprises copolyesters containing TMCD and EG residues, the glycol component for the copolyesters can include but are not limited to at least one of the following combinations of ranges: about 10 to about 30 mole % 2,2,4,4-tetramethyl-1,3-cyclobutanediol and about 90 to about 70 mole % ethylene glycol; about 10 to about 27 mole % 2,2,4,4-tetramethyl-1,3-cyclobutanediol and about 90 to about 73 mole % ethylene glycol; about 15 to about 26 mole % 2,2,4,4-tetramethyl-1,3-cyclobutanediol and about 85 to about 74 mole % ethylene glycol; about 18 to about 26 mole % 2,2,4,4-tetramethyl-1,3-cyclobutanediol and about 82 to about 77 mole % ethylene glycol; about 20 to about 25 mole % 2,2,4,4-tetramethyl-1,3-cyclobutanediol and about 80 to about 75 mole % ethylene glycol; about 21 to about 24 mole % 2,2,4,4-tetramethyl-1,3-cyclobutanediol and about 79 to about 76 mole % ethylene glycol; or about 22 to about 24 mole % 2,2,4,4-tetramethyl-1,3-cyclobutanediol and about 78 to about 76 mole % ethylene glycol.

In certain embodiments, where the first layer comprises copolyesters containing TMCD and EG residues, the copolyesters may exhibit at least one of the following inherent viscosities as determined in 60/40 (wt/wt) phenol/tetrachloroethane at a concentration of 0.25 g/50 ml at 25° C. from 0.50 to 0.8 dL/g; 0.55 to 0.75 dL/g; 0.57 to 0.73 dL/g; 0.58 to 0.72 dL/g; 0.59 to 0.71 dL/g; 0.60 to 0.70 dL/g; 0.61 to 0.69 dL/g; 0.62 to 0.68 dL/g; 0.63 to 0.67 dL/g; 0.64 to 0.66 dL/g; or about 0.65 dL/g.

In certain embodiments, where the first layer comprises copolyesters containing TMCD and EG residues, the Tg of the copolyester can be chosen from one of the following ranges: 85 to 110° C., 85 to 100° C.; 86 to 99° C.; 87 to 98° C.; 88 to 97° C.; 89 to 96° C.; 90 to 95° C.; 91 to 95° C.; 92 to 94° C.; 90 to 110° C.; 95 to 110° C.

In other embodiments, where the first layer comprises copolyesters containing TMCD and EG residues, the copolyester comprises diol residues comprising 30 to 42 mole percent TMCD residues and 58 to 70 mole percent EG residues. In one embodiment, the copolyester comprises diol residues comprising 33 to 38 mole percent TMCD residues and 62 to 67 mole percent EG residues.

In certain embodiments, where the first layer comprises copolyesters containing TMCD and EG residues, the copolyester comprises: a) a dicarboxylic acid component comprising: (i) 90 to 100 mole % terephthalic acid residues; and (ii) about 0 to about 10 mole % of aromatic and/or aliphatic dicarboxylic acid residues having up to 20 carbon atoms; and (b) a glycol component comprising: (i) about 30 to about 40 mole % 2,2,4,4-tetramethyl-1,3-cyclobutanediol (TMCD) residues; and (ii) about 70 to about 60 mole % ethylene glycol residues; and wherein the total mole % of the dicarboxylic acid component is 100 mole %, and wherein the total mole % of the glycol component is 100 mole %; and wherein the inherent viscosity (IV) of the polyester is from 0.50 to 0.80, or 0.50 to 0.75, or 0.50 to 0.70, or 0.55 to 0.80, or 0.55 to 0.75, or 0.55 to 0.70, 0.60 to 0.80, or 0.60 to 0.75, or 0.60 to 0.70 dL/g as determined in 60/40 (wt/wt) phenol/tetrachloroethane at a concentration of 0.25 g/50 ml at 25° C.; and wherein the L* color values for the polyester is 90 or greater, as determined by the L*a*b* color system measured following ASTM D 6290-98 and ASTM E308-99, performed on polymer granules ground to pass a 1 mm sieve. In embodiments, the L* color values for the polyester is greater than 90, as determined by the L*a*b* color system measured following ASTM D 6290-98 and ASTM E308-99, performed on polymer granules ground to pass a 1 mm sieve.

In certain embodiments, where the first layer comprises copolyesters containing TMCD and EG residues, the glycol component comprises: (i) about 32 to about 40 mole % 2,2,4,4-tetramethyl-1,3-cyclobutanediol (TMCD) residues, and (ii) about 68 to about 60 mole % ethylene glycol residues; or (i) about 34 to about 40 mole % 2,2,4,4-tetramethyl-1,3-cyclobutanediol (TMCD) residues, and (ii) about 66 to about 60 mole % ethylene glycol residues; or (i) greater than 34 to about 40 mole % 2,2,4,4-tetramethyl-1,3-cyclobutanediol (TMCD) residues, and (ii) less than 66 to about 60 mole % ethylene glycol residues; or (i) 34.2 to about 40 mole % 2,2,4,4-tetramethyl-1,3-cyclobutanediol (TMCD) residues, and (ii) 65.8 to about 60 mole % ethylene glycol residues; or (i) about 35 to about 39 mole % 2,2,4,4-tetramethyl-1,3-cyclobutanediol (TMCD) residues, and (ii) about 65 to about 61 mole % ethylene glycol residues; or (i) about 36 to about 37 mole % 2,2,4,4-tetramethyl-1,3-cyclobutanediol (TMCD) residues; and (ii) about 64 to about 63 mole % ethylene glycol residues.

In certain embodiments, where the first layer comprises copolyesters containing TMCD and EG residues, the copolyester has at least one of the following properties chosen from: a Tg of from about 100 to about 110° C. as measured by a TA 2100 Thermal Analyst Instrument at a scan rate of 20° C./min, a flexural modulus at 23° C. of equal to or greater than 2000 MPa (about 290,000 psi), or greater than 2200 MPa (319,000 psi) as defined by ASTM D790, a notched Izod impact strength of about 30 J/m (0.56 ft-lb/in) to about 80 J/m (1.50 ft-lb/in) according to ASTM D256 with a 10-mil notch using a ⅛-inch thick bar at 23° C., and less than 5% loss in inherent viscosity after being held at a temperature of 293° C. (560° F.) for 2 minutes. In one embodiment, the L* color values for the polyester composition is 90 or greater, or greater than 90, as determined by the L*a*b* color system measured following ASTM D 6290-98 and ASTM E308-99, performed on polymer granules ground to pass a 1 mm sieve.

In one embodiment, where the first layer comprises copolyesters containing TMCD and EG residues, the copolyester comprises a diol component having at least 30 mole percent TMCD residues (based on the diols) and a catalyst/stabilizer component comprising: (i) titanium atoms in the range of 10-60 ppm based on polymer weight, (ii) manganese atoms in the range of 10-100 ppm based on polymer weight, and (iii) phosphorus atoms in the range of 10-200 ppm based on polymer weight. In one embodiment, the 2,2,4,4-tetramethyl-1,3-cyclobutanediol residues is a mixture comprising more than 50 mole % of cis-2,2,4,4-tetramethyl-1,3-cyclobutanediol residues and less than 50 mole % of trans-2,2,4,4-tetramethyl-1,3-cyclobutanediol residues.

In certain embodiments, the glycol component for the copolyesters includes but is not limited to at least one of the following combinations of ranges: about 30 to about 40 mole % 2,2,4,4-tetramethyl-1,3-cyclobutanediol and about 60 to 70 mole % ethylene glycol; about 32 to about 40 mole % 2,2,4,4-tetramethyl-1,3-cyclobutanediol and about 60 to 68 mole % ethylene glycol; about 32 to about 38 mole % 2,2,4,4-tetramethyl-1,3-cyclobutanediol and about 64 to 68 mole % ethylene glycol; about 33 to about 40 mole % 2,2,4,4-tetramethyl-1,3-cyclobutanediol and about 60 to 67 mole % ethylene glycol; about 34 to about 40 mole % 2,2,4,4-tetramethyl-1,3-cyclobutanediol and about 60 to 66 mole % ethylene glycol; greater than 34 to about 40 mole % 2,2,4,4-tetramethyl-1,3-cyclobutanediol and 60 to less than 66 mole % ethylene glycol; 34.2 to 40 mole % 2,2,4,4-tetramethyl-1,3-cyclobutanediol and about 60 to 65.8 mole % ethylene glycol; about 35 to about 39 mole % 2,2,4,4-tetramethyl-1,3-cyclobutanediol and about 61 to 65 mole % ethylene glycol; about 35 to about 38 mole % 2,2,4,4-tetramethyl-1,3-cyclobutanediol and about 62 to 65 mole % ethylene glycol; or about 36 to about 37 mole % 2,2,4,4-tetramethyl-1,3-cyclobutanediol and about 63 to 64 mole % ethylene glycol.

In certain embodiments, where the first layer comprises copolyesters containing TMCD and EG residues, the polyesters may exhibit at least one of the following inherent viscosities as determined in 60/40 (wt/wt) phenol/tetrachloroethane at a concentration of 0.25 g/50 ml at 25° C. from 0.50 to 0.80 dL/g; 0.50 to 0.75 dL/g; 0.50 to 0.70 dL/g; 0.55 to 0.80 dL/g; 0.55 to 0.75 dL/g; 0.55 to 0.70 dL/g; 0.55 to 0.65 dL/g; 0.56 to 0.64 dL/g; 0.56 to 0.63 dL/g; 0.56 to 0.62 dL/g; 0.56 to 0.61 dL/g; 0.57 to 0.64 dL/g; 0.58 to 0.64 dL/g; 0.57 to 0.63 dL/g; 0.57 to 0.62 dL/g; 0.57 to 0.61 dL/g; 0.58 to 0.60 dL/g; about 0.59 dL/g; 0.60 to 0.80 dL/g; 0.60 to 0.75 dL/g; or 0.60 to 0.70 dL/g.

In certain of the embodiments, where the first layer comprises copolyesters containing TMCD and EG residues, such copolyesters can contain less than 10 mole %, or less than 5 mole %, or less than 4 mole %, or less than 3 mole %, or less than 2 mole %, or less than 1 mole %, or no, CHDM residues.

In embodiments, the polyesters described herein for use in the first layer may exhibit at least one of the following inherent viscosities as determined in 60/40 (wt/wt) phenol/tetrachloroethane at a concentration of 0.5 g/100 ml at 25° C.: 0.10 to 1.2 dL/g; 0.10 to 1.1 dL/g; 0.10 to 1 dL/g; 0.10 to less than 1 dL/g; 0.10 to 0.98 dL/g; 0.10 to 0.95 dL/g; 0.10 to 0.90 dL/g; 0.10 to 0.85 dL/g; 0.10 to 0.80 dL/g; 0.10 to 0.75 dL/g; 0.10 to less than 0.75 dL/g; 0.10 to 0.72 dL/g; 0.10 to 0.70 dL/g; 0.10 to less than 0.70 dL/g; 0.10 to 0.68 dL/g; 0.10 to less than 0.68 dL/g; 0.10 to 0.65 dL/g; 0.20 to 1.2 dL/g; 0.20 to 1.1 dL/g; 0.20 to 1 dL/g; 0.20 to less than 1 dL/g; 0.20 to 0.98 dL/g; 0.20 to 0.95 dL/g; 0.20 to 0.90 dL/g; 0.20 to 0.85 dL/g; 0.20 to 0.80 dL/g; 0.20 to 0.75 dL/g; 0.20 to less than 0.75 dL/g; 0.20 to 0.72 dL/g; 0.20 to 0.70 dL/g; 0.20 to less than 0.70 dL/g; 0.20 to 0.68 dL/g; 0.20 to less than 0.68 dL/g; 0.20 to 0.65 dL/g; 0.35 to 1.2 dL/g; 0.35 to 1.1 dL/g; 0.35 to 1 dL/g; 0.35 to less than 1 dL/g; 0.35 to 0.98 dL/g; 0.35 to 0.95 dL/g; 0.35 to 0.90 dL/g; 0.35 to 0.85 dL/g; 0.35 to 0.80 dL/g; 0.35 to 0.75 dL/g; 0.35 to less than 0.75 dL/g; 0.35 to 0.72 dL/g; 0.35 to 0.70 dL/g; 0.35 to less than 0.70 dL/g; 0.35 to 0.68 dL/g; 0.35 to less than 0.68 dL/g; 0.35 to 0.65 dL/g; 0.40 to 1.2 dL/g; 0.40 to 1.1 dL/g; 0.40 to 1 dL/g; 0.40 to less than 1 dL/g; 0.40 to 0.98 dL/g; 0.40 to 0.95 dL/g; 0.40 to 0.90 dL/g; 0.40 to 0.85 dL/g; 0.40 to 0.80 dL/g; 0.40 to 0.75 dL/g; 0.40 to less than 0.75 dL/g; 0.40 to 0.72 dL/g; 0.40 to 0.70 dL/g; 0.40 to less than 0.70 dL/g; 0.40 to 0.68 dL/g; 0.40 to less than 0.68 dL/g; 0.40 to 0.65 dL/g; greater than 0.42 to 1.2 dL/g; greater than 0.42 to 1.1 dL/g; greater than 0.42 to 1 dL/g; greater than 0.42 to less than 1 dL/g; greater than 0.42 to 0.98 dL/g; greater than 0.42 to 0.95 dL/g; greater than 0.42 to 0.90 dL/g; greater than 0.42 to 0.85 dL/g; greater than 0.42 to 0.80 dL/g; greater than 0.42 to 0.75 dL/g; greater than 0.42 to less than 0.75 dL/g; greater than 0.42 to 0.72 dL/g; greater than 0.42 to less than 0.70 dL/g; greater than 0.42 to 0.68 dL/g; greater than 0.42 to less than 0.68 dL/g; and greater than 0.42 to 0.65 dL/g.

For certain embodiments, the polyesters described herein in embodiments for the second layer comprising 1,4-cyclohexane dicarboxylate may exhibit at least one of the following inherent viscosities as determined in 60/40 (wt/wt) phenol/tetrachloroethane at a concentration of 0.5 g/100 ml at 25° C.: 0.45 to 1.50 dL/g; 0.45 to 1.40 dL/g; 0.45 to 1.30 dL/g; 0.45 to 1.25 dL/g; 0.45 to 1.20 dL/g; 0.45 to 1.15 dL/g; 0.45 to 1.10 dL/g; 0.45 to 1.05 dL/g; 0.45 to less than 1 dL/g; 0.50 to 1.50 dL/g; 0.50 to 1.40 dL/g; 0.50 to 1.30 dL/g; 0.50 to less than 1.25 dL/g; 0.60 to 1.30 dL/g; 0.60 to 1.20 dL/g; 0.60 to 1.10 dL/g; 0.70 to 1.30 dL/g; 0.70 to 1.20 dL/g; 0.70 to 1.10 dL/g; 0.80 to less than 1.5 dL/g; 0.80 to 1.45 dL/g; 0.80 to 1.40 dL/g; 0.80 to less than 1.40 dL/g; 0.80 to 1.35 dL/g; 0.80 to less than 1.3 dL/g; 0.80 to 1.25 dL/g; 0.80 to 1.20 dL/g; 0.80 to 1.15 dL/g; 0.80 to 1.10 dL/g; 0.80 to less than 1.10 dL/g; 0.80 to 1.05 dL/g; 0.80 to 1.00 dL/g; 0.80 to 0.95 dL/g; 0.80 to 0.90 dL/g; 0.85 to 1.50 dL/g; 0.85 to 1.40 dL/g; 0.85 to less than 1.40 dL/g; 0.85 to 1.35 dL/g; 0.85 to 1.30 dL/g; 0.85 to less than 1.30 dL/g; 0.85 to 1.25 dL/g; 0.85 to less than 1.25 dL/g; 0.85 to 1.20 dL/g; 0.85 to 1.15 dL/g; 0.85 to 1.10 dL/g; 0.85 to 1.05 dL/g; 0.85 to less than 1.0 dL/g; 0.90 to 1.50 dL/g; 0.90 to 1.40 dL/g; 0.90 to 1.30 dL/g; 0.90 to 1.25 dL/g; 0.90 to 1.20 dL/g; 0.90 to 1.15 dL/g; 0.90 to 1.10 dL/g; 0.90 to 1.05 dL/g; 0.90 to 1.10 dL/g; 1.0 to less than 1.50 dL/g; 1.0 to 1.4 dL/g; 1.0 to less than 1.3 dL/g; 1.0 to less than 1.25 dL/g; 1.0 to 1.20 dL/g; 1.0 to 1.10 dL/g; 1.05 to 1.25 dL/g; 1.05 to less than 1.25 dL/g; 1.05 to 1.20 dL/g; 1.05 to 1.15 dL/g; 1.05 to 1.10 dL/g; greater than 0.80 dL/g to 1.50 dL/g; greater than 0.80 dL/g to 1.40 dL/g; greater than 0.80 dL/g to less than 1.30 dL/g; greater than 0.85 dL/g to 1.30 dL/g; greater than 0.85 dL/g to 1.25 dL/g; greater than 0.85 dL/g to 1.20 dL/g; greater than 0.85 dL/g to 1.15 dL/g; greater than 0.85 dL/g to 1.10 dL/g; greater than 0.85 dL/g to 1.05 dL/g; greater than 0.85 dL/g to 1.0 dL/g; greater than 0.90 dL/g to 1.30 dL/g; greater than 0.95 dL/g to 1.30 dL/g; greater than 1.0 dL/g to 1.30 dL/g.

In certain embodiments, the acid component for the second layer comprising 1,4-cyclohexane dicarboxylate includes but is not limited to at least one of the following combinations of ranges: about 90 to about 100 mole % 1,4-cyclohexane dicarboxylic acid residues; and about 0 to 10 mole % aromatic and/or aliphatic dicarboxylic acid residues having up to 20 carbon atoms; about 90 to about 98 mole % 1,4-cyclohexane dicarboxylic acid residues and about 2 to 10 mole % modifying aromatic and/or aliphatic dicarboxylic acid residues having up to 20 carbon atoms; about 90 to about 95 mole % 1,4-cyclohexane dicarboxylic acid residues and about 5 to 10 mole % modifying aromatic and/or aliphatic dicarboxylic acid residues having up to 20 carbon atoms; about 90 to about 93 mole % 1,4-cyclohexane dicarboxylic acid residues and about 7 to 10 mole % modifying aromatic and/or aliphatic dicarboxylic acid residues having up to 20 carbon atoms; about 92 to about 100 mole % 1,4-cyclohexane dicarboxylic acid residues and about 0 to 8 mole % modifying aromatic and/or aliphatic dicarboxylic acid residues having up to 20 carbon atoms; about 95 to about 100 mole % 1,4-cyclohexane dicarboxylic acid residues and about 0 to 5 mole % modifying aromatic and/or aliphatic dicarboxylic acid residues having up to 20 carbon atoms; about 98 to about 100 mole % 1,4-cyclohexane dicarboxylic acid residues and about 0 to 2 mole % modifying aromatic and/or aliphatic dicarboxylic acid residues having up to 20 carbon atoms; or about 100 mole % 1,4-cyclohexane dicarboxylic acid residues and no modifying aromatic and/or aliphatic dicarboxylic acid residues having up to 20 carbon atoms.

In certain embodiments, the glycol component for the second layer comprising 1,4-cyclohexane dicarboxylate includes but is not limited to at least one of the following combinations of ranges: about 90 to about 100 mole % 1,4-cyclohexanedimethanol residues and about 0 to 10 mole % modifying glycol residues; about 90 to about 98 mole % 1,4-cyclohexanedimethanol residues and about 2 to 10 mole % modifying glycol residues; about 90 to about 95 mole % 1,4-cyclohexanedimethanol residues and about 5 to 10 mole % modifying glycol residues; about 90 to about 93 mole % 1,4-cyclohexanedimethanol residues and about 7 to 10 mole % modifying glycol residues; about 92 to about 100 mole % 1,4-cyclohexanedimethanol residues and about 0 to 8 mole % modifying glycol residues; about 95 to about 100 mole % 1,4-cyclohexanedimethanol residues and about 0 to 5 mole % modifying glycol residues; about 98 to about 100 mole % 1,4-cyclohexanedimethanol residues and about 0 to 2 mole % modifying glycol residues; or about 100 mole % 1,4-cyclohexanedimethanol residues and no modifying glycol residues.

In embodiments, the 1,4-cyclohexane dicarboxylate polyester useful for the second layer has an inherent viscosity (IV) in a range from 0.70 to 1.5 dL/g, or 0.75 to 1.3 dL/g, or 0.8 to 1.2 dL/g, 0.8 to 1.1 dL/g, or 0.85 to 1.1 dL/g, or 0.85 to 1.0 dL/g, as determined in 60/40 (wt/wt) phenol/tetrachloroethane at a concentration of 0.5 g/100 ml at 25° C. In embodiments, the 1,4-cyclohexane dicarboxylate polyester useful for the second layer has a glass transition temperature (Tg) or less than 110° C., or less than 100° C., or less than 90° C., or less than 80° C., or in the range from 30° C. to 100° C., or 40° C. to 90° C., 50° C. to 80° C., or 60° C. to 75° C., or 60° C. to 70° C., measured by DSC. In embodiments, the 1,4-cyclohexane dicarboxylate polyester useful for the second layer has an elongation at break of at least 50%, or at least 75%, or at least 100%, or at least 200%, or in the range of 50% to 300%, or 100% to 200%, or 200% to 300%, measured according to ASTM D 638; and/or a flexural modulus in the range of 500 to 2000 MPa, or 750 to 1500 MPa, or 800 to 1200 MPa, or 900 to 1100 MPa, or 1000 to 1100 MPa, measured according to ASTM D 790; and/or a tear strength of at least 10 N, or at least 50 N, or at least 100 N, or in the range from 10 N to 200 N, or 10 N to 150 N, or 10 N to 100 N, measured according to ASTM D 1004. In embodiments, the 1,4-cyclohexane dicarboxylate polyester useful for the second layer has a Rockwell hardness greater than R80, or greater than R85, or greater than R87, or in a range from R80 to R110, or R80 to R105, or R80 to R100, or R80 to R95, or R80 to R90, or R85 to R110, or R85 to R105, or R85 to R100, or R85 to R95, or R85 to R90, or R87 to R110, or R87 to R105, or R87 to R100, or R87 to R95, or R88 to R110, or R88 to R105, or R88 to R100, or R88 to R95. In embodiments, the 1,4-cyclohexane dicarboxylate polyester useful for the second layer has a Durometer/Rockwell hardness greater than D65, or greater than D70, or in a range from greater than D70 and up to R110, or up to R105, or up to R100, or up to R95, or up to R 90.

In embodiments, the second layer can further comprise a polyesterether or copolyester ether (COPE), e.g., (PCCE) commercially available, for example, from Eastman Chemical Company. The term “polyesters” as used herein with respect to the second layer, is intended to include copolyesterethers. The copolyesterethers can be derived from a dicarboxylic acid component comprising and/or consisting essentially of 1,4-cyclohexanedicarboxylic acid or an ester forming derivative thereof such as dimethyl-1,4-cyclohexanedicarboxylate. This acid and ester are both sometimes referred to herein as DMCD. The diol component consists essentially of 1,4-cyclohexanedimethanol (CHDM) and polytetramethylene ether glycol (PTMG). The copolyesterethers further can comprise branching agents, for example, from about 0.1 to about 1.5 mole %, based on the acid or glycol component, of a polyfunctional branching agent having at least 3 carboxyl or hydroxyl groups.

In embodiments, the dibasic acid component of the copolyesterether comprises residues of 1,4-cyclohexanedicarboxylic acid or dimethyl-1,4-cyclohexanedicarboxylate having a trans isomer content of at least 65%, or at least 70% or at least 80% or at least 85%. In an embodiment, the dibasic acid component of the copolyesterether can consist essentially of DMCD and can have a trans isomer content of at least 70%, or at least 80% or at least 85%.

In embodiments, the polyesterether included in the second layer can comprise residues of 1,4-cyclohexanedicarboxylic acid or an ester thereof in the amount of from 70-100 weight % or from 80 to 100 weight % or from 90 to 100 weight % or from 95 to 100 weight % or from 98 to 100 weight %, based on a total of 100 weight % acid residues and a total of 100 weight % diol residues. The polyesterether can comprise residues of 1,4-cyclohexanedimethanol and polytetramethylene ether glycol.

In certain embodiments, the polyesterether can comprise residues of from 1 to 50 mole %, or 5 to 50 mole %, or 10 to 50 mole %, or 15 to 50 mole %, or 20 to 50 mole % or 25 to 50 mole %, or 30 to 50 mole %, or 35 to 50 mole %, or 40 to 50 mole %, or 45 to 50 mole %, or 1 to 45 mole %, or 5 to 45 mole %, or 10 to 45 mole %, or 15 to 45 mole %, or 20 to 45 mole % or 25 to 45 mole %, or 30 to 45 mole %, or 35 to 45 mole %, or 40 to 45 mole %, or 1 to 40 mole %, or 5 to 40 mole %, or 10 to 40 mole %, or 15 to 40 mole %, or 20 to 40 mole % or 25 to 40 mole %, or 30 to 40 mole %, or 35 to 40 mole %, or 1 to 35 mole %, or 5 to 35 mole %, or 10 to 35 mole %, or 15 to 35 mole %, or 20 to 35 mole % or 25 to 35 mole %, or 30 to 35 mole %, or 1 to 30 mole %, or 5 to 30 mole %, or 10 to 30 mole %, or 15 to 30 mole %, or 20 to 30 mole % or 25 to 30 mole %, or 1 to 25 mole %, or 5 to 25 mole %, or 10 to 25 mole %, or 15 to 25 mole %, or 20 to 25 mole %, or 1 to 20 mole %, or 5 to 20 mole %, or 10 to 20 mole %, or 15 to 20 mole %, or 1 to 15 mole %, or 5 to 15 mole %, or 10 to 15 mole %, or 1 to 10 mole %, or 5 to 10 mole %, or 1 to 5 mole %, of polytetramethylene ether glycol residues.

In certain embodiments, the polyesterether can comprise residues of from 1 mole % to 20 mole %, or 1 mole % to 15 mole %, or 1 mole % to 12 mole %, or 1 mole % to 10 mole %, or 3 mole % to 12 mole %, or from 5 mole % to 10 weight %, or from 7 to 10 mole %, of polytetramethylene ether glycol residues.

In one embodiment, the polyester portion of the polyesterether comprises residues of at least one glycol as described for the polyesters useful in the invention. In certain embodiments, the polyester portion of the polyesterether comprises residues of at least one glycol selected from ethylene glycol, diethylene glycol, triethylene glycol, isosorbide, propane-1,3-diol, butane-1,4-diol, 2,2-dimethylpropane-1,3-diol (neopentyl glycol), 2,2,4,4,-tetramethyl-1,3-cyclobutanediol, pentane-1,5-diol, hexane-1,6-diol, 1,4-cyclohexanedimethanol, 3-methyl-pentanediol-(2,4), 2-methylpentanediol-(1,4), 2,2,4-tri-methylpentane-diol-(1,3), 2-ethylhexanediol-(1,3), 2,2-diethylpropane-diol-(1,3), hexanediol-(1,3), 1,4-di-(hydroxyethoxy)-benzene, 2,2-bis-(4-hydroxycyclohexyl)-propane, 2,4-dihydroxy-1,1,3,3-tetramethyl-cyclobutane, 2,2-bis-(3-hydroxyethoxyphenyl)-propane, 2,2-bis-(4-hydroxypropoxyphenyl)-propane, and mixtures thereof. In embodiments, in addition to polytetramethylene ether glycol (PTMG) residues, the balance of the glycol component of the polyesterether is essentially 1,4-cyclohexanedimethanol (CHDM) residues. In embodiments, the glycol component of the polyesterether comprises less than 10 mole %, or less than 5 mole %, or less than 2 mole %, or less than 1 mole %, of glycol residues other than residues of CHDM and PTMG.

In embodiments, the polyesterether can comprise residues of from 50 weight % to 95 weight %, or from 55 weight % to 95 weight %, or from 60 weight % to 95 weight %, or from 70 weight % to 95 weight %, or from 75 weight % to 95 weight %, or from 80 weight % to 95 weight %, of 1,4-cyclohexanedimethanol residues. In embodiment, the polyesterether does not contain residues of ethylene glycol.

In embodiments, the second layer can comprise a polyesterether having an inherent viscosity (IV) in a range from 0.70 to 1.5 dL/g, or 0.8 to 1.4 dL/g, or 0.9 to 1.3 dL/g, 1.0 to 1.2 dL/g, or 1.1 to 1.2 dL/g, or 1.14 to 1.18 dL/g, as determined in 60/40 (wt/wt) phenol/tetrachloroethane at a concentration of 0.5 g/100 ml at 25° C. In embodiments, the polyesterether has a glass transition temperature (Tg) or less than 0° C., or less than −10° C., or less than −20° C., or less than −30° C., or in the range from −60° C. to 0° C., or −50° C. to −10° C., −60° C. to −20° C., or −50° C. to −30° C., measured by DSC. In embodiments, the polyesterether has an elongation at break of at least 200%, or at least 300%, or at least 350%, or in the range of 200% to 600%, or 300% to 500%, measured according to ASTM D 638; and/or a flexural modulus in the range of 50 to 250 MPa, or 100 to 200 MPa, measured according to ASTM D 790; and/or a tear strength of at least 200 N, or at least 250 N, or at least 300 N, or in the range from 200 N to 500N, or 250 N to 450 N, or 300 N to 400 N, measured according to ASTM D 1004.

In one embodiment, copolyesterether contained in the second layer can have an inherent viscosity of from about 0.70 to about 1.5 dL/g as determined in 60/40 (wt/wt) phenol/tetrachloroethane at a concentration of 0.5 g/100 ml at 25° C. and can comprise:
A. a dicarboxylic acid component comprising and/or consisting essentially of 1,4-cyclohexanedicarboxylic acid, and
B. a glycol component consisting essentially of
   (1) 1,4-cyclohexanedimethanol, and
   (2) from about 1 to about 50 mole percent, or from 1 to 20 mole percent, or from 1 to 15 mole percent, or from 2 to 10 mole percent, based on the moles of the glycol component of the polyesterether, of polytetramethyleneether glycol (PTMG) having a weight average molecular weight of about 500 to about 2000.

In one embodiment, the copolyesterether can further comprise (3) from about 0.1 to about 1.5 mole %, or 0.1 to 1.0 mole % based on the total mole % of the acid or glycol component, of a branching agent having at least three COOH or OH functional groups and from 3 to 60 carbon atoms. In embodiments, the branching agent can include one or more of the branching agents, and examples of same, as described herein regarding other polyesters.

In embodiments, the second layer can further comprise a polyester having CHDM and EG glycol residues having an inherent viscosity (IV) in a range from 0.5 to 1.0 dL/g, or 0.6 to 0.9 dL/g, or 0.65 to 0.85 dL/g, 0.7 to 0.8 dL/g, as determined in 60/40 (wt/wt) phenol/tetrachloroethane at a concentration of 0.5 g/100 ml at 25° C. In embodiments, the copolyester has a glass transition temperature (Tg) or greater than 60° C., or greater than 70° C., or greater than 75° C., or in the range from 60° C. to 100° C., or 70° C. to 90° C., or 75° C. to 85° C. measured by DSC. In embodiments, the copolyester has an elongation at break of at least 80%, or at least 100%, or at least 120%, or in the range of 80% to 180%, or 100% to 160%, measured according to ASTM D 638; and/or a flexural modulus in the range of 1600 to 2600 MPa, or 1800 to 2400 MPa, or 2000 to 2200 MPa, measured according to ASTM D 790; and/or a tear force of at least 25 N, or at least 30 N, or at least 35 N, or in the range from 25 N to 100N, or 30 N to 80 N, or 35 N to 60 N, measured according to ASTM D1938.

The relative amounts of each component in a blend containing polyesters according to various embodiments (for the second layer) is described below. For purposes of this application: “TMCD and CHDM polyester” refers to any of the embodiments described herein for polyesters containing both TMCD and CHDM residues in the diol component of the polyester; “TMCD and EG polyester” refers to any of the embodiments described herein for polyesters containing both TMCD and EG residues in the diol component of the polyester; “isosorbide polyester” refers to any of the embodiments described herein for polyesters containing isosorbide residues in the diol component of the polyester; “1,4-cyclohexane dicarboxylate polyester” refers to any of the embodiments described herein for polyesters containing 1,4-cyclohexane dicarboxylate (CHDA) residues in the diacid component of the polyester, except for polyesterethers that having CHDA residues; “polyesterether” refers to any of the embodiments described herein for polyesters containing a polyesterether in the diol component of the polyester, and “CHDM and EG polyester” refers to any of the embodiments described herein for polyesters containing both CHDM and EG residues (and no TMCD) in the diol component of the polyester.

In embodiments, the second layer can comprise a composition that comprises a polyester component (A) containing a 1,4-cyclohexane dicarboxylate polyester, and a polyester component (B) containing a polyesterether in one or the following amounts: 50 to 99 wt % component (A) and 1 to 50 wt % component (B), or greater than 50 to 99 wt % component (A) and 1 to less than 50 wt % component (B), or 55 to 99 wt % component (A) and 1 to 45 wt % component (B), or 60 to 99 wt % component (A) and 1 to 40 wt % component (B), or 65 to 99 wt % component (A) and 1 to 35 wt % component (B), or 70 to 99 wt % component (A) and 1 to 30 wt % component (B), or 75 to 99 wt % component (A) and 1 to 25 wt % component (B), or 80 to 99 wt % component (A) and 1 to 20 wt % component (B), or 55 to 95 wt % component (A) and 5 to 45 wt % component (B), or 60 to 95 wt % component (A) and 5 to 40 wt % component (B), or 65 to 95 wt % component (A) and 5 to 35 wt % component (B), or 70 to 95 wt % component (A) and 5 to 30 wt % component (B), or 75 to 95 wt % component (A) and 5 to 25 wt % component (B), or 80 to 95 wt % component (A) and 5 to 20 wt % component (B), or 55 to 90 wt % component (A) and 10 to 45 wt % component (B), or 60 to 90 wt % component (A) and 10 to 40 wt % component (B), or 65 to 90 wt % component (A) and 10 to 35 wt % component (B), or 70 to 90 wt % component (A) and 10 to 30 wt % component (B), or 75 to 90 wt % component (A) and 10 to 25 wt % component (B), or 80 to 90 wt % component (A) and 10 to 20 wt % component (B).

In embodiments, the second layer can comprise a composition that comprises a polyester component (A) containing a 1,4-cyclohexane dicarboxylate polyester, and a polyester component (B) containing a CHDM and EG polyester, in one or the following amounts: greater than 50 to 99 wt % component (A) and 1 to less than 50 wt % component (B), or 55 to 99 wt % component (A) and 1 to 45 wt % component (B), or 60 to 99 wt % component (A) and 1 to 40 wt % component (B), or 65 to 99 wt % component (A) and 1 to 35 wt % component (B), or 70 to 99 wt % component (A) and 1 to 30 wt % component (B), or 75 to 99 wt % component (A) and 1 to 25 wt % component (B), or 80 to 99 wt % component (A) and 1 to 20 wt % component (B), or 55 to 95 wt % component (A) and 5 to 45 wt % component (B), or 60 to 95 wt % component (A) and 5 to 40 wt % component (B), or 65 to 95 wt % component (A) and 5 to 35 wt % component (B), or 70 to 95 wt % component (A) and 5 to 30 wt % component (B), or 75 to 95 wt % component (A) and 5 to 25 wt % component (B), or 80 to 95 wt % component (A) and 5 to 20 wt % component (B), or 55 to 90 wt % component (A) and 10 to 45 wt % component (B), or 60 to 90 wt % component (A) and 10 to 40 wt % component (B), or 65 to 90 wt % component (A) and 10 to 35 wt % component (B), or 70 to 90 wt % component (A) and 10 to 30 wt % component (B), or 75 to 90 wt % component (A) and 10 to 25 wt % component (B), or 80 to 90 wt % component (A) and 10 to 20 wt % component (B).

In certain embodiments, the polyester component (A) as described herein is a minority component of the second layer composition. In such embodiments, the majority component can be polyester component (B) as described in any of the embodiments herein.

In certain embodiments, the multiple layer structure film is a two-layer structure. In embodiments, the multiple layer structure film is a three-layer structure having a core layer and two outer layers, one on each side of the core layer. In embodiments, the core layer contains the second layer composition and the outer layers are made from the first layer composition. In other embodiments, the core layer contains the first layer composition and the outer layers are made from the second layer composition.

As noted above, the overall thickness of the sheet can range from about 100 μm to about 3000 μm, or about 300 μm to about 3000 μm. In other embodiments, the thickness of the sheet ranges from about 380 μm to about 1600 μm, or about 500 μm to about 1000 μm, or about 600 μm to about 900 μm, or about 700 μm to about 800 μm. In certain embodiments, the thickness of the second layer ranges from about 1 μm to about 1000 μm. In certain embodiments, the thickness of the second layer ranges from about 1 μm to about 725 μm, or 1 μm to 600 μm, or 100 μm to 650 μm, or 200 μm to 550 μm, or 300 μm to 450 μm. In certain embodiments, the thickness of the first layer ranges from about 1 μm to about 2000 μm. In a further embodiment, the first layer thickness ranges from about 25 μm to about 1000 μm, or 100 μm to 650 μm, or 200 μm to 550 μm, or 300 μm to 450 μm.

The multilayer sheets of this invention can be produced by co-extrusion, extrusion laminating, heat laminating, adhesive laminating and the like. In co-extrusion multiple layers of polymers are generated by melting the polymer compositions for each layer in different extruders which are fed into a coextrusion block or die. A multi-layer sheet or film is formed in the block or die. Extrusion laminating is a process in which at least two sheets or films (monolayer or co-ex) are bonded together by extruding a polymer melt between them, creating a multilayer structure. Adhesive laminating takes at least two sheets or films (monolayer or co-ex) and bonds them together using a liquid adhesive to create a multilayer sheet or film. Heat laminating is a batch process in which cut sheets or films of various compositions or structures are laid up in a heated press. Multiple combinations and multiple layers can be made using these methods.

In the event the multilayer sheet having the first and second layers chosen as described herein tend to separate or delaminate from each other during processing or usage, at least one intermediate “tie layer” may be utilized between such layers. In one embodiment, the multilayer film has at least three film layers comprising a first layer A and second layer B, and a tie layer between layers A and B, i.e., “A-tie-B”. In certain embodiments, such tie layers comprise one or more copolymers selected from polyethylene copolymers, polypropylene copolymers, anhydride modified polyolefins, acid/acrylate modified ethylene vinyl acetate copolymer, acid modified ethylene acrylate, anhydride modified ethylene acrylate, modified ethylene acrylate, modified ethylene vinyl acetate, anhydride modified ethylene vinyl acetate copolymer, anhydride modified high density polyethylene, anhydride modified linear low density polyethylene, anhydride modified low density polyethylene, anhydride modified polypropylene, ethylene ethyl acrylate maleic anhydride copolymer and ethylene butyl acrylate maleic anhydride terpolymer, ethylene-alpha-olefin copolymers, alkene-unsaturated carboxylic acid or carboxylic acid derivative copolymers, ethylene-methacrylic acid copolymers, ethylene-vinyl acetate copolymers, ethylene-methacrylic acid copolymers, unsaturated dicarboxylic acid anhydride grafted copolymers, maleic anhydride grafted ethylene-vinyl acetate copolymers, maleic anhydride grafted polyethylene, styrene-butadiene copolymers, C3 or higher alpha-olefin copolymers having a high alpha-olefin comonomer content, propylene-1-butene copolymers, and mixtures thereof.

In embodiments, the multilayer sheet has a tear force of at least 10 N, or at least 15 N, or at least 20 N, measured according to ASTM D 1938; and/or a force retention percent of 25% or more, or 28% or more, or 30% or more, or a range of 25 to 45%, or 30 to 40%, measured as described in the examples herein; and/or a flexural modulus greater than 1500 MPa, or at least 1550 MPa, or at least 1600 MPa, or in the range from greater than 1500 up to 2400 MPa, or greater than 1500 up to 2200 MPa, or greater than 1500 up to 2100 MPa, or 1550 to 2200 MPa, or 1550 to 2100 MPa, or greater than 1500 up to 2000 MPa, or 1550 to 2000 MPa, or 1600 to 2000 MPa, or 1600 to 1800 MPa, measured according to ASTM D 790. In embodiments, the multilayer sheet has both the tear force and force retention properties described above. In embodiments, the multilayer sheet has each of the tear force, force retention and flexural modulus properties described above. In embodiments, the multilayer sheet has a tensile modulus greater than 1050 MPa, or at least 1100 MPa, or at least 1200 MPa, or in the range from greater than 1050 up to 1600 MPa, or greater than 1050 up to 1500 MPa, or greater than 1050 up to 1400 MPa, or 1050 to 1600 MPa, or 1050 to 1500 MPa, or greater than 1100 up to 1600 MPa, or 1200 to 1600 MPa, or 1200 to 1500 MPa, or 1250 to 1500 MPa, measured according to ASTM D882.

In embodiments, the multilayer sheet has a total thickness in the range from 100 to 1050 microns, or 500 to 1050 microns, or 500 to 1000 microns, or 600 to 900 microns, or 600 to 800 microns, or 635 microns (25 mils) to 889 microns (35 mils), or 635 microns (25 mils) to 762 microns (30 mils). In embodiments, the thickness of the second layer is from 10 to 75%, or 10 to 70%, or 10 to 65%, or 10 to 60%, or 10 to 55%, or 10 to 50%, or 15 to 45%, or 20 to 40%, or 20 to 35%, or 25 to 35% of the total thickness of the multilayer sheet. In embodiments, the thickness of the second layer is from 20 to 75%, or 20 to 70%, or 20 to 65%, or 20 to 60%, or 20 to 55%, or 20 to 50%, or 25 to 75%, or 25 to 70%, or 25 to 65%, or 25 to 60%, or 25 to 55%, or 25 to 50%, or 30 to 75%, or 30 to 70%, or 30 to 65%, or 30 to 60%, or 30 to 55%, or 30 to 50%, or 35 to 75%, or 35 to 70%, or 35 to 65%, or 35 to 60%, or 35 to 55%, or 35 to 50% of the total thickness of the multilayer sheet.

Due to its structure as having high modulus and stain resistance, the sheets of the invention are useful in preparing removable orthodontic tooth positioning appliances, insofar as the sheets of the invention possess sufficiently high modulus and superior tear resistance. See for example, U.S. Pat. Nos. 9,655,691; 9,655,693; and 10,052,176, incorporated herein by reference.

Accordingly, in a further embodiment, the invention provides a removable orthodontic tooth positioning appliance having teeth receiving cavities shaped to directly receive at least some of a patient's teeth, said appliance comprising a multi-layer polymer structure formed from a sheet comprising at least two layers, said two layers comprising layers comprising a first layer and a second layer, wherein:
(A) said first layer comprises a polyester comprising:
   (a) a dicarboxylic acid component comprising:
      i) 70 to 100 mole % of terephthalic acid residues; and
      ii) 0 to 30 mole % of aromatic and/or aliphatic dicarboxylic acid residues having up to 20 carbon atoms; and
   (b) a glycol component comprising:
      i) 10 to 40 mole % of 2,2,4,4-tetramethyl-1,3-cyclobutanediol residues;
      ii) 0 to 90 mole % of 1,4-cyclohexanedimethanol residues; and
      iii) 0 to 90 mole % of ethylene glycol residues; and
having an inherent viscosity of about 0.4 to about 1.2 dL/g as determined in 60/40 (wt/wt) phenol/tetrachloroethane at a concentration of 0.5 g/100 ml at 25° C.; and
(B) said second layer comprises a polyester comprising:
   (a) a dicarboxylic acid component comprising:
      i) 70 to 100 mole % of dicyclohexane dicarboxylic acid residues;
      ii) 0 to 30 mole % of aromatic and/or aliphatic dicarboxylic acid residues having up to 20 carbon atoms; and
   (b) a glycol component comprising:
      i) 40 to 100 mole % of 1,4-cyclohexanedimethanol residues;
      ii) 0 to 60 mole % of ethylene glycol residues; and
having an inherent viscosity of 0.5 to 1.2 dL/g as determined in 60/40 (wt/wt) phenol/tetrachloroethane at a concentration of 0.5 g/100 ml at 25° C.; and
   wherein the overall thickness of the sheet is between 100 and 3000 microns.

In a further embodiment, said first layer comprises a polyester comprising:
(a) a dicarboxylic acid component comprising:
   i) 90 to 100 mole % of terephthalic acid residues;
   ii) 0 to 10 mole % of aromatic and/or aliphatic dicarboxylic acid residues having up to 20 carbon atoms; and
(b) a glycol component comprising:
   i) 10 to 40 mole % of 2,2,4,4-tetramethyl-1,3-cyclobutanediol residues;
   ii) 60 to 90 mole % of 1,4-cyclohexanedimethanol residues; and
has an inherent viscosity of about 0.5 to about 0.9 dL/g as determined in 60/40 (wt/wt) phenol/tetrachloroethane at a concentration of 0.5 g/100 ml at 25° C.

In a further embodiment, said first layer comprises a polyester comprising:
(a) a dicarboxylic acid component comprising:
   (i) 90 to 100 mole % of terephthalic acid residues;
   ii) 0 to 10 mole % of aromatic and/or aliphatic dicarboxylic acid residues having up to 20 carbon atoms; and
(b) a glycol component comprising:
   i) 10 to 40 mole % of 2,2,4,4-tetramethyl-1,3-cyclobutanediol residues;
   ii) 60 to 90 mole % of ethylene glycol residues; and
has an inherent viscosity of about 0.4 to about 1.2 dL/g as determined in 60/40 (wt/wt) phenol/tetrachloroethane at a concentration of 0.5 g/100 ml at 25° C. In a further embodiment, the inherent viscosity of the first layer is between about 0.5 and 0.7 dL/g.

In a further embodiment, the invention provides a removable orthodontic tooth positioning appliance having teeth receiving cavities shaped to directly receive at least some of a patient's teeth, said appliance comprising a multi-layer polymer structure formed from a sheet comprising at least two layers, said two layers comprising layers comprising a first layer and a second layer, wherein:
said second layer comprises a polyester comprising:
   (a) a dicarboxylic acid component comprising:
      i) 70 to 100 mole % of dicyclohexane dicarboxylic acid residues;
      ii) 0 to 30 mole % of aromatic and/or aliphatic dicarboxylic acid residues having up to 20 carbon atoms; and
   (b) a glycol component comprising:
      i) 40 to 100 mole % of 1,4-cyclohexanedimethanol residues;
      ii) 0 to 60 mole % of ethylene glycol residues; and
         having an inherent viscosity of 0.5 to 1.2 dL/g as determined in 60/40 (wt/wt) phenol/tetrachloroethane at a concentration of 0.5 g/100 ml at 25° C.

In embodiments, the dental appliance can made from any of the multilayer sheets described herein.

This invention can be further illustrated by the following examples of certain embodiments thereof, although it will be understood that these examples are included merely for purposes of illustration and are not intended to limit the scope of the invention unless otherwise specifically indicated.

### EXAMPLES

Films/sheets were prepared by coextruding multilayer films from the following resins:
Resin 1=Eastman Tritan™ Copolyester MP100
Resin 2=Eastman Neostar™ Polyester 19972
Resin 3=Ecdel™ Elastomer 9966

### Example 1

A two-layer film (having an AAB structure) was coextruded using a 30 mm single screw extruder (Extruder A1) and a 25 mm single screw extruder (Extruder A2) for the “AA” layer, and a 30 mm single screw extruder (Extruder B) for the “B” layer of the films. Each of the extruders used a 600 mm width flat coat hanger die. The “AA” layer of the film was made from Resin 1. The “B” layer of the film was made from Resin 2. Extrusion conditions that were used are shown below in Table 1.

TABLE 1
Coextrusion Conditions

| | Extruder A1 | Extruder A2 | Extruder B |
|---|---|---|---|
| Extruder Zone | (AA layer) | (AA layer) | (B layer) |
| 1 | 265° C. | 260° C. | 245° C. |
| 2 | 260° C. | 260° C. | 245° C. |
| 3 | 255° C. | 255° C. | 245° C. |
| 4 | 255° C. | 255° C. | 245° C. |
| Adapter | 250° C. | 250° C. | 245° C. |

| | |
|---|---|
| Die | 255° C. |
| Top roll | 55° C. |
| Middle roll | 50-55° C. |
| Bottom roll | 65° C. |

The overall thickness of the coextruded film was 750 microns with the AA layer and the B layer each being about 375 microns.

### Comparative Example 1

A two-layer film (having an AAB structure) was coextruded in a similar manner to Example 1, where the “AA” layer of the film was made from Resin 1, but where the “B” layer of the film was made from Resin 3. Extrusion conditions that were used can be found in table 2 below.

TABLE 2
Coextrusion Conditions

| | Extruder A1 | Extruder A2 | Extruder B |
|---|---|---|---|
| Extruder Zone | (AA layer) | (AA layer) | (B layer) |
| 1 | 265° C. | 260° C. | 210° C. |
| 2 | 260° C. | 260° C. | 210° C. |
| 3 | 255° C. | 255° C. | 210° C. |
| 4 | 255° C. | 255° C. | 210° C. |
| Adapter | 250° C. | 250° C. | 230° C. |

| | |
|---|---|
| Die | 250-255° C. |
| Top roll | 55° C. |
| Middle roll | 35° C. |
| Bottom roll | 25° C. |

The extruded films/sheets were tested for tensile and flexural properties, tear strength, stress relaxation properties and stain resistance, as described below.

### Test Methods

The coextruded films were tested in accordance with ASTM standard test methods for flexural modulus, flexural strength, flexural strain at flexural strength, tensile modulus, tensile yield strength, tensile elongation at yield, and for flexural and tear properties, as listed below in Table 3.

TABLE 3
Test methods for flexural, tensile and tear properties

| | | | Sample | |
|---|---|---|---|---|
| Property | Unit | Standard | Size | Test Specifications |
| Yield strength | N/mm² | ASTM | 25.4 × | Grip to grip: 50 mm |
| Elongation at | % | D882 | 125 mm | Speed: 500 mm/min |
| yield | | | | Preload: 1.5N |
| Tensile | N/mm² | | | Load cell: 10 kN |
| strength | | | | Samples: 10 |
| Elongation at | % | | | |
| break | | | | |
| Flexural | N/mm² | ASTM | 10 × | Span: 26.8 mm |
| modulus | | D790 | 75 mm | Speed: 2 mm/min |
| | | ISO 178 | | Pre-load: 0.1-1.0N |
| | | | | (depending on the |
| | | | | sample and |
| | | | | direction) |
| | | | | Load cell: 500N |
| | | | | Samples: 10 |
| Average tear | N/mm | ASTM | 25 × | Grip to grip: 50 mm |
| drop | | 1938 (low | 75 mm | Speed: 250 mm/min |
| resistance | | extensible | (50 mm | Pre-load: 5N |
| Average tear | N | film) | slit) | Load cell: 50N |
| force | | | | Samples: 10 |
| Force | % | ASTM | | Samples per run: 1 |
| retention | | E328 | | (only MD) |
| Thickness | μm | N/A | N/A | Measured using |
| | | | | Keyence microscope, |
| | | | | total and layer |
| | | | | thickness over 5 |
| | | | | points on 1 sample |

Plaque/film color is measured in transmittance mode according to ASTM E1348. Color measurements made in transmittance or reflectance are recorded as CIELAB values, calculated in accordance with ASTM E308. Delta E calculations are determined according to ASTM D2244.

Force retention properties of the films were determined using a dynamic mechanical analyzer (DMA) at elevated temperature and humidity. Samples were cut to a dimension of 3.175 mm wide by 10 mm long in the machine direction (MD) of the film. The samples were conditioned at 37° C. and 90% relative humidity for 60 min before being displaced at a strain of 0.5% prior to the start of testing. The temperature and humidity were held constant at 37° C. and 90% relative humidity for 24 hours and the change in force was measured for the duration of the test. The amount of force, in Newtons, at the beginning of the test was compared to the amount of force remaining after 24 hours. The calculation yielding the percentage loss was determined for each of the films based upon the initial force and the force remaining after 24 hours.

Film thickness measurements for total thickness, as well as the individual layer thickness, of each film was determined using an optical microscope to view the cross-section of each film for a measurement to be taken. An average of 5 measurements spread over the width of the film was used to determine average film thickness.

Stain resistance was evaluated by evaluating the changes in L*a*b* (ΔE) after exposure to coffee by submerging a test sheet sample cut to a size of about 2.5 cm (1 inch) wide and 5.1 cm (2 inches) long at 37° C. for specific times (shown in Table 7 below). The coffee was lungo coffee made using a Douwe Egberts coffee machine. The above color measurements were conducted at 23±2° C. and 50±10% relative humidity within 2 months after production of the films.

### Test Results

The results of the testing for the films are listed below in tables 4-9.

TABLE 4
Comparison of flexural properties of the films

| | | Average of | Average of | Average of |
|---|---|---|---|---|
| | | Flexural | Flexural | Flexural Strain |
| | | Modulus | Strength | @ Flexural |
| Sample | Direction | (MPa) | (MPa) | Strength (%) |
| Comparative | MD | 984 | 32.6 | 4.2 |
| Ex 1 | TD | 1307 | 38.9 | 4.3 |
| Example 1 | MD | 2092 | 67.9 | 3.6 |
| | TD | 1957 | 71.3 | 3.8 |
| Change (%) | MD | 112.6 | 108.2 | −14.2 |
| | TD | 49.7 | 83.3 | −11.6 |

TABLE 5
Comparison of tensile properties of the films

| | | Average | Average | Average | Average |
|---|---|---|---|---|---|
| | | of | of | of | of |
| | | Tensile | Yield | Elongation | Elongation |
| | Direc- | Modulus | Strength | at Yield | at Break |
| Sample | tion | (MPa) | (MPa) | (%) | (%) |
| Comparative | MD | 1031 | 34.2 | 10.8 | 247.5 |
| Ex 1 | TD | 1006 | 32.3 | 8.8 | 248.8 |
| Example 1 | MD | 1277 | 45.5 | 7.1 | 198.1 |
| | TD | 1320 | 44.3 | 7.4 | 171.9 |
| Change (%) | MD | 23.8 | 33.0 | −34.3 | −20.0 |
| | TD | 31.2 | 37.2 | −16.0 | −30.9 |

TABLE 6
Comparison of tear properties of the films

| | | Average Tear | Average Tear Propagation |
|---|---|---|---|
| Sample | Direction | Load (N) | Resistance (N/mm) |
| Comparative | MD | 15.1 | 18.1 |
| Ex 1 | TD | 16.7 | 20.5 |
| Example 1 | MD | 21.9 | 27.6 |
| | TD | 22.9 | 28.7 |
| Change (%) | MD | 45.0 | 52.5 |
| | TD | 37.1 | 40.0 |

TABLE 7
Comparison of force retention of the films

| | Initial Tensile | Tensile Modulus | Force |
|---|---|---|---|
| Sample | Modulus (MPa) | after aging (MPa) | Retention (%) |
| Comparative | 568 | 194 | 34.2 |
| Ex 1 | | | |
| Example 1 | 1071 | 351 | 32.8 |

TABLE 8
Comparison of stain resistance of the films

ΔE

| Sample | 1 hr | 6 hrs | 24 hrs | 48 hrs | 72 hrs |
|---|---|---|---|---|---|
| Comparative | 3.43 | 6.59 | 10.92 | 12.69 | 14.47 |
| EX 1 | | | | | |
| Example 1 | 0.48 | 0.57 | 0.68 | 0.61 | 0.57 |

TABLE 9
Comparison of average film thickness

| Sample | Layer | Average Film Layer Thickness (microns) |
|---|---|---|
| Comparative | B | 322 |
| EX 1 | AA | 462 |
| Example 1 | B | 350 |
| | AA | 418 |

A review of tables 4-8 reveals that example 1 shows a higher flexural modulus and flexural strength. Example 1 also shows a higher tensile modulus and tensile strength, as well as higher tear force/tear propagation resistance, compared to comparative example 1. Table 7 shows the films had comparable stress relaxation properties, but example 1 had a higher absolute E-modulus after exposure to 37° C./90% RH for 24 hours. Example 1 also had significantly better stain resistance (to coffee) as shown in table 8 by the change in color as a function of exposure time to coffee at 37° C.

### Comparative Examples 2-4

Monolayer films were extruded on a single screw extruder. Comparative example 2 was produced using resin 1, comparative example 3 was produced using resin 2, and comparative example 4 was produced using resin 3. Extrusion conditions that were used can be found in table 10 below.

TABLE 10
Extrusion Conditions

| | | |
|---|---|---|
| Zone 1 | 250°-270° | C. |
| Zone 2 | 250°-265° | C. |
| Zone 3 | 250°-260° | C. |
| Zone 4 | 250°-260° | C. |
| Zone 5 | 250°-260° | C. |
| Die | 260°-270° | C. |
| Top roll | 50°-71° | C. |
| Middle roll | 45°-66° | C. |
| Bottom roll | 30°-43° | C. |

The film thickness target for each of comparative examples 3, 4 and 5 monolayer films was 750 microns.

### Comparative Example 5

A Three-layer film (having an A-B-A structure) was coextruded using a single screw extruder for the “A” layers, and a single screw extruder for the “B” layer of the film. The “A” layers of the film were made from Resin 1. The “B” layer of the film was made from Resin 3. Extrusion conditions that were used are shown below in table 11.

TABLE 11
Coextrusion Conditions

| Extruder Zone | Extruder A (outer layers) | Extruder B (core layer) |
|---|---|---|
| 1 | 270° C. | 255° C. |
| 2 | 265° C. | 255° C. |
| 3 | 260° C. | 260° C. |
| 4 | 260° C. | 260° C. |
| 5 | 260° C. | 260° C. |
| Die | 265° C. | — |
| Top roll | 70° C. | — |
| Middle roll | 65° C. | — |
| Bottom roll | 40° C. | — |

The thickness of the Resin 1 A layers was about 250 microns and the thickness of the resin 3 B layer was about 250 microns.

Comparative examples 2-5 extruded films/sheets were tested for tensile and flexural properties, tear strength, and stress relaxation properties as described above. The results are shown below in table 12.

TABLE 12
Comparison of film thickness distribution of the films

| | Comp. Ex. | Comp. Ex. | Comp. Ex. | Comp. Ex. |
|---|---|---|---|---|
| Property | 2 | 3 | 4 | 5 |
| Average | 2077 | 1557 | 189 | 1644 |
| Flexural | | | | |
| modulus | | | | |
| (MPa) | | | | |
| Average | 53 | 54.1 | 6.3 | 84.2 |
| flexural | | | | |
| strength | | | | |
| (MPa) | | | | |
| Average | 1328 | 991 | 168 | 928 |
| Tensile | | | | |
| modulus | | | | |
| (MPa) | | | | |
| Average Yield | 45.3 | 34.7 | 10.9 | 32.3 |
| strength | | | | |
| (MPa) | | | | |
| Average | 5.2 | 4.4 | 17.4 | 5.8 |
| elongation at | | | | |
| yield (%) | | | | |
| Average | 91.9 | 70.2 | 99.2 | 89.7 |
| elongation at | | | | |
| break (%) | | | | |
| average tear | 21.9 | 44.8 | 36.1 | 73.8 |
| load (N) | | | | |
| average tear | 27.7 | 63.3 | 43.8 | 101.2 |
| propagation | | | | |
| resistance | | | | |
| (N/mm) | | | | |
| force retention | 55 | 2 | 21 | 52 |
| (%) | | | | |

A review of Table 12 reveals that comparative example 2 has low tear load and low tear propagation. Comparative example 3 has low force retention and low elongation at yield. Comparative example 4 has low flexural strength and low force retention. Comparative example 5 has a balance of properties, but is made with resin 3 and would have poor stain resistance.

### Examples 2-6

Two-material films (having an AAB or ABB structure) were coextruded using a 30 mm single screw extruder (Extruder 1, top die), a 25 mm single screw extruder (Extruder 2, middle die), and a 30 mm single screw extruder (Extruder 3, bottom die). Each of the extruders used a 600 mm width flat coat hanger die. Films were made having a Resin 1 layer and a Resin 2 layer of varying relative thicknesses. The film was extruded through a die and passed through a 3 vertical chill roller assembly with chill roll 1 at the bottom, chill roll 2 in the middle and chill roll 3 at the top. The extruded film passed through the nip between chill rolls 1 and 2, with the Resin 2 layer side contacting chill roll 1, the film wrapped around chill roll 2 and passed through the nip between chill rolls 2 and 3, with the Resin 2 layer side contacting chill roll 3, and the film wrapped around chill roll 3 and exited the chill roll assembly. The film extruding conditions are listed in Table 13 below.

TABLE 13
Film Extrusion Conditions

| | Example 2 | | | Example 3 | | | Example 4 | | | Example 5 | | | Example 6 | | |
|---|---|---|---|---|---|---|---|---|---|---|---|---|---|---|---|
| | Extruder | | | Extruder | | | Extruder | | | Extruder | | | Extruder | | |
| Parameter | 1 | 2 | 3 | 1 | 2 | 3 | 1 | 2 | 3 | 1 | 2 | 3 | 1 | 2 | 3 |
| Resin | 1 | 1 | 2 | 1 | 1 | 2 | 1 | 1 | 2 | 1 | 2 | 2 | 1 | 2 | 2 |
| KF-moisture (ppm) | 69 | 69 | 93 | 69 | 69 | 93 | 69 | 69 | 93 | 166 | 156 | 165 | 166 | 156 | 165 |
| Avg. Total Film Thickness (μm) | 740-780 | | | 750-800 | | | 760-810 | | | 750-810 | | | 730-760 | | |
| Approx. Layer | 375 | | 375 | 500 | | 250 | 600 | | 150 | 250 | 500 | | 150 | 600 | |
| Thickness (μm) | | | | | | | | | | | | | | | |
| Extruder Zone 1 Temp (° C.) | 265 | 265 | 265 | 265 | 265 | 265 | 265 | 265 | 265 | 265 | 265 | 265 | 265 | 265 | 265 |
| Extruder Zone 2 Temp (° C.) | 260 | 260 | 260 | 260 | 260 | 260 | 260 | 260 | 260 | 260 | 260 | 260 | 260 | 260 | 260 |
| Extruder Zone 3 Temp (° C.) | 255 | 255 | 255 | 255 | 255 | 255 | 255 | 255 | 255 | 255 | 255 | 255 | 255 | 255 | 255 |
| Extruder Zone 4 Temp (° C.) | 255 | 255 | 255 | 255 | 255 | 255 | 255 | 255 | 255 | 255 | 255 | 255 | 255 | 255 | 255 |
| Extruder Zone 5 Temp (° C.) | 255 | 255 | 255 | 255 | 255 | 255 | 255 | 255 | 255 | 255 | 255 | 255 | 255 | 255 | 255 |
| Die Adapt Temp (° C.) | 250 | 250 | 250 | 250 | 250 | 250 | 250 | 250 | 250 | 250 | 250 | 250 | 250 | 250 | 250 |
| Chill roll 1 (Lower) | 35 | 35 | 35 | 35 | 35 | 35 | 35 | 35 | 35 | 35 | 35 | 35 | 35 | 35 | 35 |
| Temp (° C.) | | | | | | | | | | | | | | | |
| Chill roll 2 (Mid) Temp (° C.) | 65 | 65 | 65 | 65 | 65 | 65 | 65 | 65 | 65 | 65 | 65 | 65 | 65 | 65 | 65 |
| Chill roll 2 (Top) Temp (° C.) | 55 | 55 | 55 | 55 | 55 | 55 | 55 | 55 | 55 | 55 | 55 | 55 | 55 | 55 | 55 |

The films of examples 2-6 were tested to determine flexural modulus, tensile modulus, tensile properties (yield strength, elongation at yield, and elongation at break), trouser tear strength, and stress retention.

Test results for flexural modulus, tensile modulus, tensile properties (yield strength, elongation at yield, and elongation at break), trouser tear strength, and stress retention are listed below in Tables 14 and 15. Table 14: Flexural, Tensile and Tear Property Test Results Sample Direction Avg. Avg. Avg. Avg. Avg. Avg.

TABLE 14
Flexural, Tensile and Tear Property Test Results

| | | | | | | | Avg. |
|---|---|---|---|---|---|---|---|
| | | Avg. | Avg. | Avg. | Avg. | Avg. | Tear |
| | | Flex. | Tens. | Yield | Elong. @ | Elong. @ | Prop. |
| | | Mod. | Mod. | Strength | Yield | Break | Resist. |
| Sample | Direction | (MPa) | (MPa) | (MPa) | (%) | (%) | (N/mm) |
| Ex. 2 | MD | 1877 | 1281 | 45.5 | 7.6 | 216.4 | 25.45 |
| | TD | 1617 | 1264 | 44.4 | 7.4 | 113.8 | 27.71 |
| Ex. 3 | MD | 1809 | 1441 | 47.6 | 7.7 | 235.0 | 25.70 |
| | TD | 1385 | 1339 | 46.2 | 7.4 | 139.6 | 27.23 |
| Ex. 4 | MD | 1808 | 1437 | 48.0 | 8.1 | 241.1 | 27.93 |
| | TD | 1658 | 1369 | 46.4 | 8.0 | 242.5 | 25.25 |
| Ex. 5 | MD | 1767 | 1174 | 42.7 | 6.7 | 39.5 | 28.45 |
| | TD | 1642 | 1134 | 42.4 | 6.6 | 49.4 | 33.68 |
| Ex. 6 | MD | 1719 | 1068 | 40.2 | 6.5 | 20.5 | 33.10 |
| | TD | 1498 | 1052 | 39.8 | 6.3 | 10.6 | 31.69 |

A review of Table 14 reveals that examples 2-4 had the highest flexural modulus; examples 3 and 4 had the highest tensile modulus, yield strength, elongation at yield, and elongation at break; examples 5 and 6 had the highest tear resistance; and that example 4 had the overall best combination of all properties.

The average tear propagation resistance (for average of MD and TD) and stress retention test results are listed below in Table 15.

TABLE 15
Average Tear and Stress Retention Test Results

| | Avg. Tear | Stress | Stress after 24 h | Stress |
|---|---|---|---|---|
| | Prop. Resist. | at Start | at 37 C./90% RH | Retention |
| Sample | (N/mm) | (MPa) | (MPa) | (%) |
| Ex. 2 | 26.6 | 5.64 | 1.88 | 33.8 |
| Ex. 3 | 26.6 | 5.59 | 2.00 | 36.1 |
| Ex. 4 | 26.6 | 7.41 | 2.76 | 39.8 |
| Ex. 5 | 31.1 | 5.37 | 1.81 | 34.1 |
| Ex. 6 | 32.4 | 4.87 | 0.70 | 14.5 |

A review of Table 15 reveals that example 5 and 6 films had the highest average tear propagation and that all the films had higher tear propagation than the Resin 1 monolayer film. It also reveals that examples 4 and 3 had the highest stress retention and performed the closest to the Resin 1 monolayer film.

Color change after thermoforming the films of examples 2-6 into dental aligners was evaluated. The color testing results for the films and thermoformed aligners are listed below in table 16.

TABLE 16
Color of Films and Formed Aligners

| Sample | Parameter | Ex. 2 | Ex. 3 | Ex. 4 | Ex. 5 | Ex. 6 |
|---|---|---|---|---|---|---|
| Unformed Film | L* | 96.39 | 96.45 | 96.49 | 96.49 | 96.63 |
| | a* | −0.03 | −0.04 | −0.05 | −0.03 | −0.04 |
| | b* | 0.44 | 0.47 | 0.29 | 0.56 | 0.71 |
| Thermoformed | L* | 91.79 | 94.67 | 95.98 | 93.07 | 91.17 |
| Aligner | a* | 0.31 | 0.23 | 0.12 | 0.36 | 0.37 |
| | b* | 1.28 | −0.03 | −0.2 | 1.37 | 2.22 |

A review of Table 16 reveals that Examples 3 and 4 had the best color, i.e., most clear and transparent, after being thermoformed into dental aligners. Thermoformed samples with higher L* are preferred.

The invention has been described in detail with particular reference to certain embodiments thereof, but it will be understood that variations and modifications can be affected within the spirit and scope of the invention.

1. A multi-layer sheet comprising at least two layers, said at least two layers comprising a first layer and a second layer, wherein:
(A) said first layer comprises a polyester comprising:
(a) a dicarboxylic acid component comprising:
i) 70 to 100 mole % of terephthalic acid residues; and
ii) 0 to 30 mole % of aromatic and/or aliphatic dicarboxylic acid residues having up to 20 carbon atoms; and
(b) a glycol component comprising:
i) 10 to 40 mole % of 2,2,4,4-tetramethyl-1,3-cyclobutanediol residues;
ii) 0 to 90 mole % of 1,4-cyclohexanedimethanol residues; and
iii) 0 to 90 mole % of ethylene glycol residues; and
having an inherent viscosity of about 0.4 to about 1.2 dL/g as determined in 60/40 (wt/wt) phenol/tetrachloroethane at a concentration of 0.5 g/100 ml at 25° C.; and
(B) said second layer comprises a polyester comprising:
(a) a dicarboxylic acid component comprising:
i) 70 to 100 mole % of dicyclohexane dicarboxylic acid residues;
ii) 0 to 30 mole % of aromatic and/or aliphatic dicarboxylic acid residues having up to 20 carbon atoms; and
(b) a glycol component comprising:
i) 40 to 100 mole % of 1,4-cyclohexanedimethanol residues;
ii) 0 to 60 mole % of ethylene glycol residues; and
having an inherent viscosity of 0.5 to 1.2 dL/g as determined in 60/40 (wt/wt) phenol/tetrachloroethane at a concentration of 0.5 g/100 ml at 25° C.; and
wherein the overall thickness of the sheet is between 100 and 3000 microns.

2. The sheet according to claim 1, wherein
(A) said first layer comprises a polyester comprising:
(a) a dicarboxylic acid component comprising:
i) 90 to 100 mole % of terephthalic acid residues;
ii) 0 to 10 mole % of aromatic and/or aliphatic dicarboxylic acid residues having up to 20 carbon atoms; and
(b) a glycol component comprising:
i) 10 to 40 mole % of 2,2,4,4-tetramethyl-1,3-cyclobutanediol residues;
ii) 60 to 90 mole % of 1,4-cyclohexanedimethanol residues; and
has an inherent viscosity of about 0.5 to about 0.9 dL/g, or 0.6 and 0.8 dL/g, as determined in 60/40 (wt/wt) phenol/tetrachloroethane at a concentration of 0.5 g/100 ml at 25° C.

3. The sheet according to claim 2, wherein said second layer comprises a polyester that comprises:
(a) a dicarboxylic acid component comprising:
i) 90 to 100 mole % of 1,4-cyclohexane dicarboxylic acid residues;
ii) 0 to 10 mole % of aromatic and/or aliphatic dicarboxylic acid residues having up to 20 carbon atoms; and
(b) a glycol component comprising:
i) 90 to 100 mole % of 1,4-cyclohexanedimethanol residues, and
ii) 0 to 10 mole % of modifying glycol residues; and
having an inherent viscosity of about 0.5 to about 1.2 dL/g as determined in 60/40 (wt/wt) phenol/tetrachloroethane at a concentration of 0.5 g/100 ml at 25° C.

4. The sheet according to claim 1, wherein the second layer further comprises a polyester chosen from: (i) a polyesterether that comprises residues of trans-1,4-cyclohexane dicarboxylate, 1,4-cyclohexanedimethanol, and poly(tetramethylene ether) glycol, or (ii) a polyester that comprises residues of terephthalic acid, 1,4-cyclohexanedimethanol, and ethylene glycol.

5. The sheet according to claim 4, wherein the second layer further comprises a polyesterether comprising
(a) a dicarboxylic acid component comprising:
i) 90 to 100 mole % of 1,4-cyclohexane dicarboxylic acid residues;
ii) 0 to 10 mole % of aromatic and/or aliphatic dicarboxylic acid residues having up to 20 carbon atoms; and
(b) a glycol component comprising:
i) 95 to 80 mole % of 1,4-cyclohexanedimethanol residues, and
ii) 5 to 20 mole % of poly(tetramethylene ether)glycol residues; and
has an inherent viscosity of about 0.9 to about 1.4 dL/g, or 1.02 to about 1.26 dL/g, as determined in 60/40 (wt/wt) phenol/tetrachloroethane at a concentration of 0.5 g/100 ml at 25° C.

6. The sheet according to claim 4, wherein the second layer further comprises a copolyester comprising:
(a) a dicarboxylic acid component comprising:
i) 90 to 100 mole % of 1,4-cyclohexane dicarboxylic acid residues;
ii) 0 to 10 mole % of aromatic and/or aliphatic dicarboxylic acid residues having up to 20 carbon atoms; and
(b) a glycol component comprising:
i) 15 to 65 mole % of 1,4-cyclohexanedimethanol residues, and
ii) 85 to 35 mole % ethylene glycol residues,
and has an inherent viscosity of about 0.4 to about 0.8 dL/g as determined in 60/40 (wt/wt) phenol/tetrachloroethane at a concentration of 0.5 g/100 ml at 25° C.

7. The sheet according to claim 1, wherein the sheet has a total thickness from 300 μm to 2000 μm.

8. The sheet according to claim 7, wherein the first layer has a thickness of from 25 μm to 1000 μm.

9. The sheet according to claim 1, wherein the sheet has a tear force of at least 20 N, measured according to ASTM D 1938, and a force retention percent of 25% or more, measured as described in the specification.

10. The sheet according to claim 9, wherein the sheet has a tear force in a range from 20 N to 40 N, measured according to ASTM D 1938, and a force retention percent loss in the range of 25 to 35%, measured as described in the specification.

11. The sheet according to claim 10, wherein the sheet has a flexural modulus greater than 1500 MPa, measured according to ASTM D 790.

12. The sheet according to claim 11, wherein the sheet has a flexural modulus in a range from greater than 1500 to 2100 MPa, measured according to ASTM D 790.

13. A removable orthodontic tooth positioning appliance having teeth receiving cavities shaped to directly receive at least some of a patient's teeth, said appliance comprising a multi-layer sheet according to claim 1.

14. The appliance according to claim 13, wherein said first layer comprises a polyester comprising:
(a) a dicarboxylic acid component comprising:
i) 70 to 100 mole % of terephthalic acid residues; and
ii) 0 to 30 mole % of aromatic and/or aliphatic dicarboxylic acid residues having up to 20 carbon atoms; and
(b) a glycol component comprising:
i) 10 to 40 mole % of 2,2,4,4-tetramethyl-1,3-cyclobutanediol residues;
ii) 0 to 90 mole % of 1,4-cyclohexanedimethanol residues; and
iii) 0 to 90 mole % of ethylene glycol residues; and
having an inherent viscosity of about 0.4 to about 1.2 dL/g as determined in 60/40 (wt/wt) phenol/tetrachloroethane at a concentration of 0.5 g/100 ml at 25° C.; and
said second layer comprises a polyester comprising:
(a) a dicarboxylic acid component comprising:
i) 70 to 100 mole % of dicyclohexane dicarboxylic acid residues;
ii) 0 to 30 mole % of aromatic and/or aliphatic dicarboxylic acid residues having up to 20 carbon atoms; and
(b) a glycol component comprising:
i) 40 to 100 mole % of 1,4-cyclohexanedimethanol residues;
ii) 0 to 60 mole % of ethylene glycol residues; and
having an inherent viscosity of 0.5 to 1.2 dL/g as determined in 60/40 (wt/wt) phenol/tetrachloroethane at a concentration of 0.5 g/100 ml at 25° C.; and
wherein the overall thickness of the sheet is between 100 and 3000 microns; and
wherein said sheet has a ΔE or less than 2 after exposure to coffee at 37° C. for 72 hours, measured as described herein, and a flexural modulus in a range from greater than 1500 to 2100 MPa, measured according to ASTM D 790.
